(19) United States
(12) Patent Application Publication
(10) Pub. No.: US 2007/0219817 A1
(43) Pub. Date: Sep. 20, 2007

(54) Universal Negotiation Forum

(76) Inventor: Jianqing Wu, Beltsville, MD (US)

Correspondence Address: AZ PATENT LAW FIRM, P.O. Box 1921, Beltsville, MD, 20704, US

(21) Appl. No.: 11/687,122

(22) Filed: Mar. 16, 2007

Related U.S. Application Data
(60) Provisional application No. 60/782,389, filed on Mar. 16, 2006.

(51) Int. Cl. G06Q 10/00; G06Q 30/00

(52) U.S. Cl. 705/1

(57) ABSTRACT

A negotiation system is disclosed for use in conducting formal and informal negotiations over any subject matter. The system has a web based use interface, which has a dialog board, a submission panel, and a status board. The parties in negotiation can use the web interface to use the server application to manage accounts, negotiation projects, negotiation parties, negotiation rules, history files, and email notification.

This application claims priority from the U.S. Application No. 60/782,389 with a filing date of Mar. 16, 2006.

In free marketing society, one of the rights enjoyed by business entities and people is the right to enter into contract. This right is more than the right to passively accept an agreement that has been drafted by another party. This right should include the right to actively negotiate for favorable terms.

Unfortunately, this right has not been fully enjoyed by the people in any nation. In fact, most of the contracts are drafted by one party and offered to other parties for acceptance. Obviously, the accepting party is unable to genuinely agree on the terms of the contract. This lack of true consent problem is often seen in the enforcement of agreement. Courts often construe a contract against the party who drafts it.

Several factors have contributed to the pervasiveness of lack-of-consent problem. First, the major factor is the cost of negotiation. The most popular negotiation model is that all parties join a negotiation conference and discuss their transaction. The cost for such in-person negotiation would be prohibitory. Moreover, if two parties negotiate over a transaction, there is no assurance that one or two meetings will result in an agreement. If two parties are open to negotiation, it may take several rounds of meetings. This type of negotiation is justified only for use in large business transactions.

Another mode of negotiation is negotiation by mail exchange. By using this method, one party drafts an agreement and sends the agreement by mail to the second party for review, consideration and acceptance. If the second party expresses its consent to the agreement, a binding agreement is formed. Negotiation by regular mail is very time-consuming. At the Internet age, few people have the patience to wait a few business days to see an offer or counteroffer. This negotiation mode is rarely used nowadays.

The parties may also use fax as additional and complementary communication means in mail-based negotiation. While faxes are fast and secure, the receiving party cannot conveniently edit the drafts to make a counteroffer. In other words, the receiving party has to express disagreement by independent statements that may introduce additional confusion and misunderstanding. The most effective way is always to directly edit the draft agreement to show the focus of negotiation and present the revised draft as a counteroffer. Negotiation by using fax as a communication vehicle may cause a delay. Moreover, fax transmission may be unreliable in transmitting a large number of pages of document. Negotiation by mail and fax is improper in a case where the transaction under negotiation is highly sensitive.

Yet another negotiation method is correspondence by email. This method has gained increasing popularity due to convenience, speed and low costs. Email is the most dominant negotiation vehicle today. By using email, one party first sends a draft to a second party for review and acceptance. If the second party rejects the offer, it may send a counteroffer as an attachment to a responsive email.

There are several problems in email-based negotiation. One of the problems is security. Negotiations are privileged communication in the context of settlement discussion between two adversary parties. If the transaction under negotiation involves privileged communication, trade secrets, and potential criminal liability, email is not a proper communication vehicle. Yet another problem is potential alteration of email messages. It is difficult to prove the substance if a party questions the authenticity. Due to a variety of reasons, a party may be unable to prove what is in the original messages and drafts. To prevent this problem from happening, parties often send drafts in a non-editable file such as PDF file. This creates the same problem as in case of using fax as a communication vehicle. The receiving party cannot edit it and has to start creating a counteroffer. Yet, another problem is the routine commingling of private communication with negotiation communication. The senders may make comments about irrelevant issues to the receiving part. Such comments may be harmless in the eyes of the receiving party at the time of sending, but they may be embarrassing in the eyes of a public member who reads it many years later.

Negotiation is one of the oldest traditional activities in the human history, but little has changed. Use of faxes has not significantly advanced the art. Use of email has promoted efficiency and reduced labor cost, but it has created all kinds of the problems of its own. Yet, few of email users have realized and foresee the disastrous consequence they might have to face many years later.

Server based negotiation is not an old concept, neither. It has been the subject of extensive research and exploration over the years. A server-based negotiation forum allows parties to conduct real time negotiation that is safe and secure. A number of patents have been issued in the United States. Yet, a major commercial success remains to be seen. An inherent problem is that the preference of a party concerning a transaction cannot be defined to one or more specific parameters such as price, quality of the subject, warranty length, and delivery method. In reality, a party may reject an offer for any reason.

Negotiation also happens routinely between different members of people within an organization. When a company has a major legal issue such as public offering of stock and intent to tender a firm offer to buy a large amount of asset, the company must form one voice among its major decision-makers. Even though this activity is often referenced as internal review, it is in fact an informal negotiation. Since the members have different opinions and priority, some members have to persuade others to agree to their positions. Such negotiation may revolve about an internal document such as initial public offering statement, security filing, press release regarding a milestone and an offer for the sale of assets.

The subjects of negotiation practically embrace every conceivable dimension of human activities and every phenomenon under the sun. Even in the legislative and the judiciary branches of both the state and federal governments, the lawmakers and decision-makers have to negotiate with other members of the same branch. Moreover, the subjects of negotiation are not limited to substantive matters, insignificant things such as writing style, document format, and even the size and shape of papers would be a source of disagreement among major members. If a company wants to launch a major promotional program, the subject of negotiation might be the wording of a slogan, a piece of digital voice, and a picture for conveying a program message. Accordingly, protocol for automatic evaluation of negotiation results has not gained great popularity.

All common negotiation methods share several common problems. One of the problems is that the negotiating parties do not have the same opportunity to conveniently evaluate the language in draft documents. Neither the drafter nor the reviewer knows how the wording and languages in the draft affects their substantive right because they do not have an opportunity to study the language that is used in successful agreements.

For example, different clauses are available for use to maintain the validity of an agreement when one of other clauses is invalidated in court. If both the drafting party and the accepting party see other comparable clauses, they may want to choose a different clause. Before a convenient negotiation forum is publicly available, it is neither realistic nor practical for parties to engage in fair negotiation. It is impossible for a person to determine whether a warranty statement is sufficiently fair to him until the person can review other warranty statements. It is also hard for an attorney to evaluate each of the clauses without seeing others for comparison.

The dispensing of fairness in negotiation is dictated by the rule of economics: Few people like to spend more money on negotiating a contract than the price for buying the goods and services underlying the contract. In a vast number of the “agreements”, especially those consumer agreements, true consent simply never exists. That is precisely why vendors can write anything, including a clause that forces the consumer to pay penalty for every problem originated by the vendor.

The second problem is a lack of systematic method for maintaining negotiation history files. It is well known that the legislative history files for congressional actions are well preserved. Courts often use legislative history files of a particular statute to resolve conflicts and inconsistencies in the statute. Negotiation history files are important in all cases where the interpretation of the agreement is the key to resolution of the dispute. Upon to now, no systematic approach is available for the maintenance of negotiation history files.

Casual use of email has caused serious trouble in negotiation history files. When parties use email as primary communication means, the parties cannot get identical history files. The first reason is that the communication flows back-and-forth and no identical files are possible. The second reason is associated with email delivery system. Some email messages might be filtered out or lost in transit while others might be blocked by security measure. The sending party may be unwilling to send a copy if the offer has expired, and problem of expected delay allows the sending party a chance to change its mind. Therefore, such files will never be available to the receiving party. The third reason is that email is for casual use. After two parties have exchanged mail several rounds, messages quickly pipe up, and it is hard to decipher precise history. This problem is worsen by the fact that email program may display messages in different ways and the fact that a responding party may type in its message between the lines of the original messages. Years later, such messages are incomprehensible to reviewers.

The fourth reason for the email problem arises form archiving and importing and exporting messages. When messages are archived, the user may control over how to store the messages. It is possible that some of the information is lost during the process. If people work as floater workers and have to use email on different computers at different locations, they may have to collect their email by importing and exporting methods. Once again, they have only a certain degree of control over importing and exporting methods. The fifth reason arises from user actions. Some users like to remove email attachments and store them in folders containing other files. They may edit the attachments and save them using the same names. Years later, if a party has to revisit history files, all the party can discover are puzzles such as the confusion in message flow pattern, lost attachments, all kinds of inconsistencies and unexplainable time conflicts. For example, if an email is mismatched with a wrong attachment by a mistake, the reviewer will have to solve puzzles like a reference to a subject matter that is not in the attachment, mentioning of an event that had not happened yet, and failing to mention an event that has happened.

After many rounds of sending, receiving and forwarding, archiving, importation/exportation, modifications of attachment files, saving of modified attachments, and mixing of detached attachments with other files, it is practically a nightmare to decipher negotiation histories which may be the key to the dissolution of an issue. When a controversy arises and an issue is to be decided in court, it is extremely time-consuming to process emails. For each email, an attorney has to review it for responsiveness, privilege, and significance. The attorney also needs to log all responsive documents into production log, hot document log, and privilege document log, if applicable. Due to a large volume of email and a large number of puzzles that might never be solved, litigation expenses are often prohibitory. The unresolved puzzles will directly impact the attorney's ability to effectively represent the client. The labor costs for processing email can be as high as $10 to $40 per piece.

In contrast, negotiation history files should not be maintained in other cases. In a civil case involving substantial potential liability, a settlement negotiation should be conducted without leaving any trace. In a situation where a party is sued for civil damage and also faces potential criminal liability, it may be preferable that the negotiation history files not be maintained by an agreement. Destruction of such files on an on-going basis is a sure measure to prevent privileged communication from getting into its adversarial parties by mistake or omission.

Many businesses, individuals, and law firms negotiate over business transactions and documents on a daily basis. Therefore, it is desirable to have a convenient forum that is secure, fair, convenient, intuitive, and cost-efficient. It is also desirable to have a forum, which may be used in real time negotiation. It is also desirable to have optional resources and controlling mechanisms available in managing the negotiation behaviors such as the time for expiration of tendered offer, rules on reviving an expired offers, and rejected offers, and the management of negotiation history files. All of those devices and features will promote the efficiency of negotiation and ultimately promote the spirits of the freedom of contracts.

### SUMMARY OF THE INVENTION

The negotiation system (“negotiation forum”) for at least two parties who negotiate over a subject matter, which may be a document, a concept, process, or an object, the system comprises:

a server connected to Internet through a network interface;

a client computer for each of the parties, the client computer being connected to the server by a network connection so that the party can access the server;

a graphic user interface between the server and each of the client computers, the graphic user interface containing a submission board, a dialog board, and a status board, wherein
The submission board allowing the party to submit document and send in message to other members;
The dialog board showing and updating the dialog substance of all the parties, and the dialog substance being shown to each of the parties; and
The status board displaying party identity, the identity of submitted document, the time of posting each of the tendered documents, the status board showing to each of the parties; and

Means for declaring a new agreement to each of the parties and allowing each of the parties to receive a copy of the newly formed agreement.

It is desirable to run this negotiation system securely. The system allows only the parties in negotiation to view documents and communication, but prevents the public from accessing any information about the negotiation project.

Optionally, the negotiation system may further comprise a log file in the dialog board accessible to all parties or means for a party to change/or reactivate the offer after the offer has been rejected by another offer. Optionally, the system may also include an email notification manager that will send to all parties a message concerning submitted documents or statue of the project. It may optionally include tool for managing negotiation history files.

Optionally, the system may have tool for indicating the nature of the paper as proposal or offer at the time of submission. It may also have tool for distinguishing the status of offer for each of the offers. Optionally, the system may also have a drafting tool, which may be a word processor or a server-based tool fully accessible to all the parties.

The negotiation system of the present invention does not use any methodology for evaluating the merit of competing offers and proposals. It is a forum for completely open-ended negotiation. It is intended as a convenient forum to offer unrestricted freedom to its participants.

### BRIEF DESCRIPTION OF DRAWINGS

FIG. 1 shows the basic components of the negotiation system;

FIG. 2 shows the web-based user interface having a dialog board, status board and a submission panel;

FIG. 3 shows the account manager for updating account information;

FIG. 4 shows the form for creating a negotiation project;

FIG. 5 shows a project summary displaying owned projects, participated projects, and archived protects;

FIG. 6 shows project details for a test project;

FIG. 7 shows one method for adding or inviting participants;

FIG. 8 shows the server's prompt for changing password;

FIG. 9 shows the second method for adding or inviting participants;

FIG. 10 shows one method for joining a project by a party;

FIG. 11 shows the second method for joining a project by a party;

FIG. 12 shows the form for approving or denying pending party;

FIG. 13 shows the form for changing project rules;

FIG. 14 shows preference setup for a project;

FIG. 15 shows the welcome message to a new project member.

### DETAILED DESCRIPTION OF THE INVENTION

### A. The Basic Structure of the System and User Interface

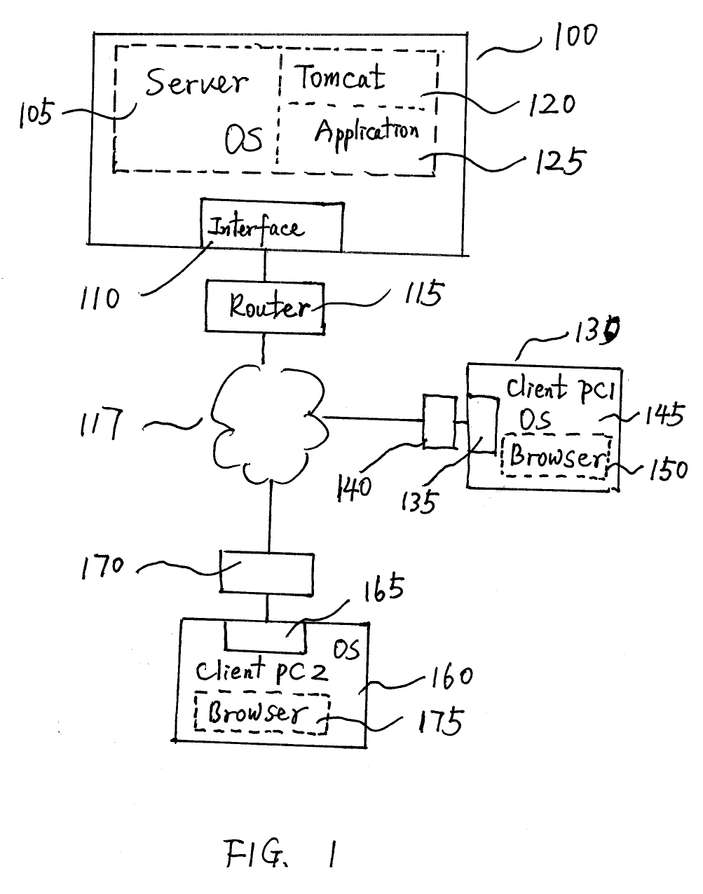

The negotiation system (FIG. 1), also referred to as negotiation forum, comprises a server 100 and client computers 130 and 160, all of them are in a network so that they are able to exchange data using common data transferring protocol such as TCP.

The server 100 is running an operating system 105 and is fully functional, has a network interface 110, and is connected to Internet 117 through a router 115. In one of the preferred embodiments, the server is made an Intel D945PNS motherboard with a Pentium D 820 processor being operated by Fedora Core 5. Although the system came with a package of Java tool, a Java Development Kid (JDK version 1.5.06) is installed for compiling Java class files. In the ext folder inside the lib folder of the Java Runtime Environment (/usr/share/jdk/jre/lib/ext), activation.jar and mail.jar are placed.

To handle file uploading, a package known as jspsmartupload (or equivalents), which includes several class files, is used. The server is installed with Apache Tomcat 5.5.15 and MYSQL 5.0.27, both of which came with the operating system. To allow Tomcat's Java class component to access the MYSQL database, mysql-connector-java.jar is placed inside the lib folder under the common folder of the Tomcat installation folder. The application files of the present invention are placed in one single folder with any suitable name.

MYSQL database application (not shown in FIGS) is used for user account management and for improving the performance in managing the files for negotiation projects. If speed and productivity is not an issue, it can be completely dispensed. The concept may be implemented by using Perl programs and DBM database. Project files, including offers, proposals, attachments, dialog log, and email address list, may be stored in project folders if no database is used.

The client computer 130 is also operated by its own operating system, has a network interface 135, and is connected to the Internet 117 through an interface 140. The client computer 130 has a browser or any similar HTML rendering application so it is able to access the server 100 using WWW protocol and access the web pages sent by the server 100 according to current standard HTTP protocols (1.0, 1.1, and 1.2).

Optionally, a second computer 160, which is also operated by its own operating system, has a network interface 165, and is connected to the Internet 117 through its router 170. The second client computer may be a virtual computer residing on the server itself. Negotiation can be conducted between two parties using a client computer and the browser on the server. Therefore, client computer may also mean a virtual computer on the server.

The application source files developed for this invention include JSP pages and Java class files. The JSP pages are located inside the application folder or its subfolders. Compiled Java class components are placed in the folders under the WEB-INF folder. Inside the application folder, there are two folders, lib and classes. The lib folder may contain some jar files for run-time use. Within the class folders, there might be plural class folders with different names, each containing one class of compiled Java files. Java components and all jar files must be compatible with the Tomcat application.

In such a system, the JSP will provide all direct interfaces with the user. The components that are used repeatedly are compiled as class files. Under this working system, web page running on browser can access the database through the JSP pages or Java classes. All JSP pages and Java source pages are developed gradually. Sine the functions implemented in this invention are relatively simple even though it is time-consuming to code.

Whenever a JSP page can run directly under the application folder forum if it complies with JSP syntax requirements. If a Java class file is developed, this file is compiled to form class file first before it is placed into a proper class folder. The Java class file is compiled using Javac from Java Development Kit (1.5.06), whose jre/lib/ext contains necessary API jar files such as mail.jar and activation.jar.

In addition, it is preferable that the server provides a drafting environment. In the alternative, the user may draft papers using a word processor such as Microsoft Word, Open Office Writer, or Corel's WordPerfect on the local computer.

Negotiation often means that negotiation between parties, but negotiation, in this disclosure, includes negotiation or discussion between members of a single party. For example, if a company wants to settle a case with an adversarial party, it has to reach an internal agreement on what terms the company wants to settle the case. Internal negotiation may use casual rules.

For the convenience, the documents under negotiation may be referenced to as agreements; they may be other legal paper, advertising design, an proposed marketing program, a photo, a flow diagram, a proposed trademark name, a price table, a sound file, and practically anything that may be a subject of disagreement among members of the organization. Therefore, “agreements” and “draft agreements” are used in this disclosure solely for the convenience. They may mean anything negotiation subject matter.

This negotiation forum allows the party to make their own choice before negotiation starts or change the governing rule on history files in the middle of game as long as all parties will agree with the change.

### B. Web-Based User Interface

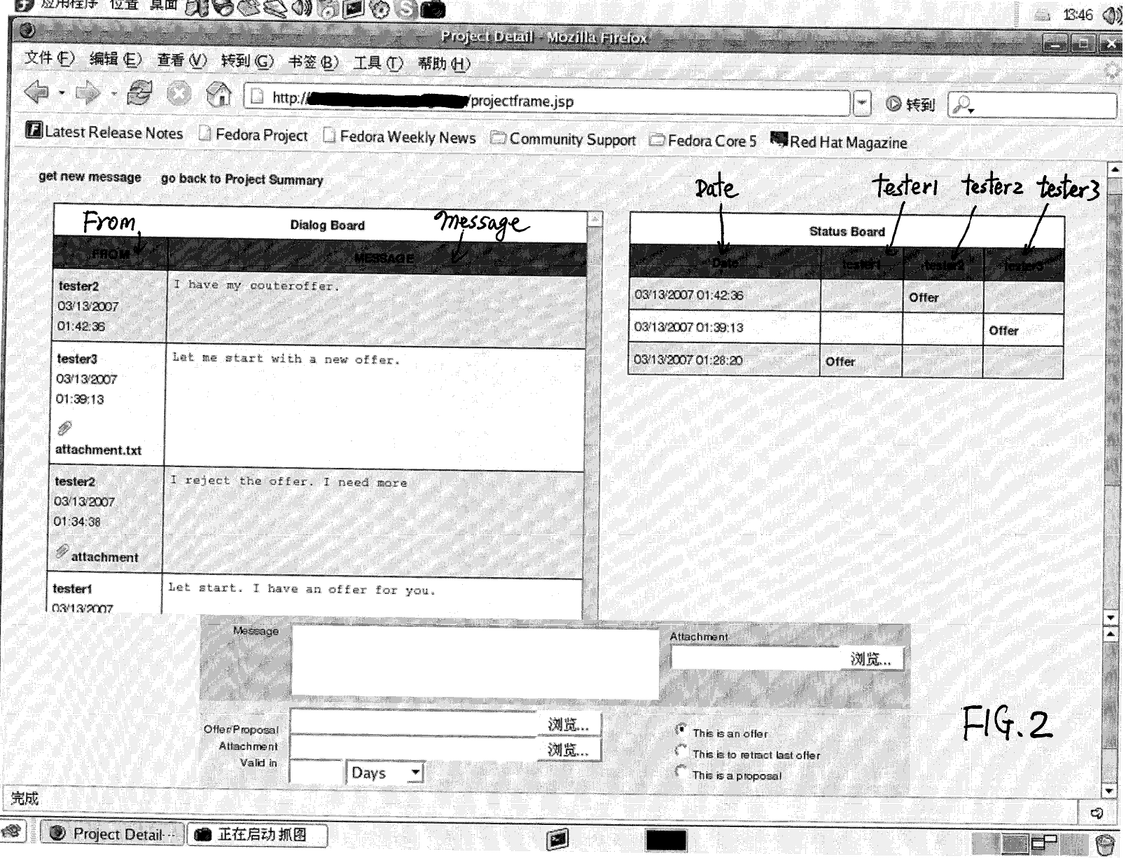

The software developed for practicing this invention includes the server-application and the code for web browser. The main component for showing dialog board, status board and submission panel viewed from a client computer are shown in the FIG. 2. This figure shows a test project under negotiation. On the left top is a dialog board and on the right top is a status board. At the bottom is a submission panel. Three parties, tester1, tester2, and tester3 are negotiating. All those windows are visible to all parties who are logged into the server. From the dialog board, tester1 started with the project and tendered an offer. This offer was logged on the status board at 1:28.

Tester2 from its own client computer sent a line to reject the offer at 1:34. Thus, the original offer is killed. Within the negotiation period, Tester3, however, tendered a new offer, which was logged on the status board at 1:39. Tester 2 however sent in a counteroffer at 1:42 and this counteroffer was logged at 1:42. Each of the parties can view the dialog histories and status board entries. They can also view any of the attached files by clicking on it. If a party wants to view 1:34 attachment by tester2, one just clicks on the attachment on the left cell (at the bottom) of tester2 1:34 entry. Each party can view any of the offers (which include counteroffers) by clicking on it.

Thus, one can quickly and conveniently review the history files and get clear picture of the on-going negotiation. Since all of the files are kept in the server, one can always accurately reconstruct the negotiation history files.

Additional features may be added to the status board. For example, all killed offers may be marked with unique color or icon. In addition, counteroffers may be marked as counteroffer. It is also referable to add an entry on the status board that kill an existing ending offer.

The software on the server includes software modules (or relevant code) for managing negotiation projects, maintaining party identity, displaying negotiation dialog, and displaying negotiation status. Optionally, it has software components or modules for setting up and changing negotiation rules, managing history files, and sending email notification. It is impossible to separate software components based upon their functions. Solely for the convenience, all the software components that jointly perform a unique function are referred to as a manager. The software used in the invention has party identity manager, project manager, dialog manager, status manager, history file manager, negotiation rule manager, and email notification manager.

Each software manager may have different software components or modules, some of which runs on the server (e.g., JSP code and Java code) and some of which runs on the client computer (HTML and JavaScript). For example, the status manager in FIG. 2 has both server side component and client-site component even though both are originated from the server. The server first creates a bulletin-like window for showing the status of the negotiation. When a party submits an offer or proposal, the submission is performed by the web page, the HTML code, rendered under the browser even though the web page has come from the server 100. After the information is submitted, the server receives the offer and statement, and processes the information and updates the status file. It then updates the status board by sending an updated web page containing updated information in the status board to the client computer for display. The status manager contains the code for generating the status board, the code of submission panel, and the code for updating the status board. It is therefore obvious that some code is shared and used by many of the managers.

Likewise, the dialog board manager has both server side component and client component. A HTML, Java or JavaScript program residing on the client side is responsible for submission of dialogs. When the server receives submitted data, it updates dialog log file or database table and then sends the updated dialog information to the dialog board of the client computer for display.

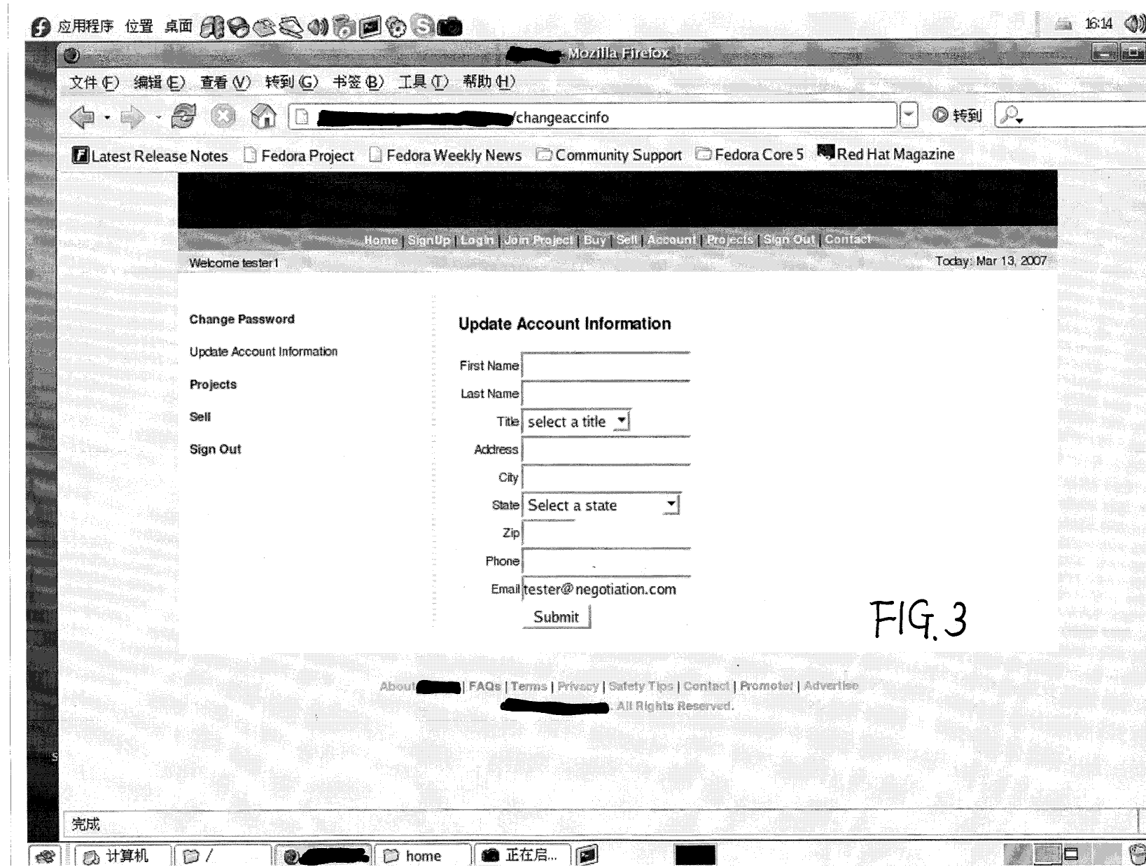

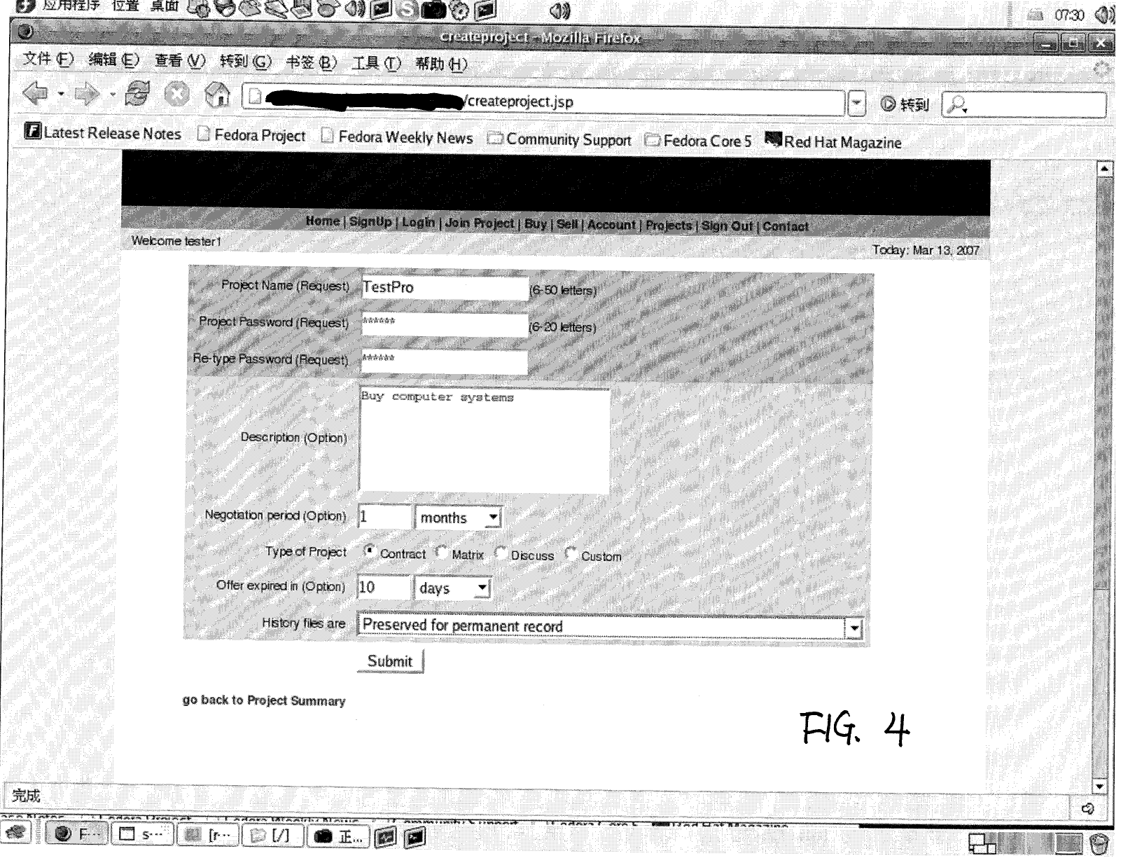

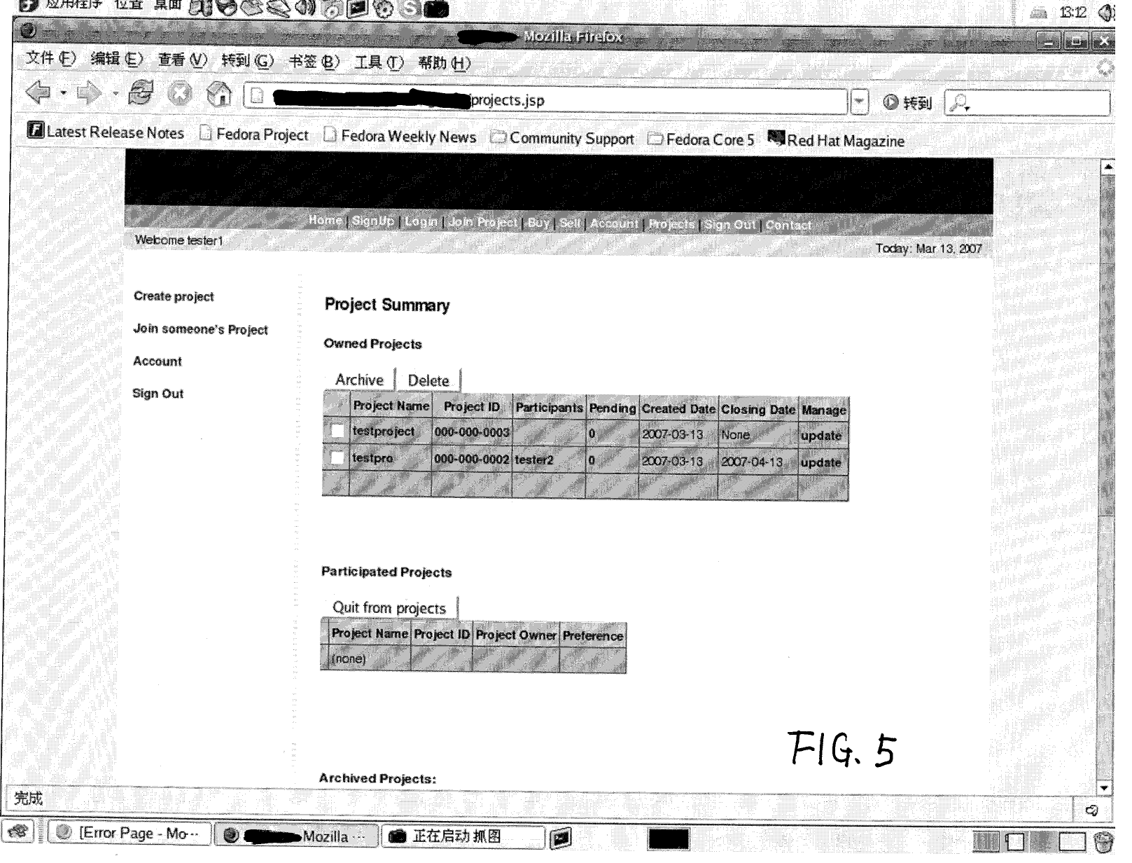

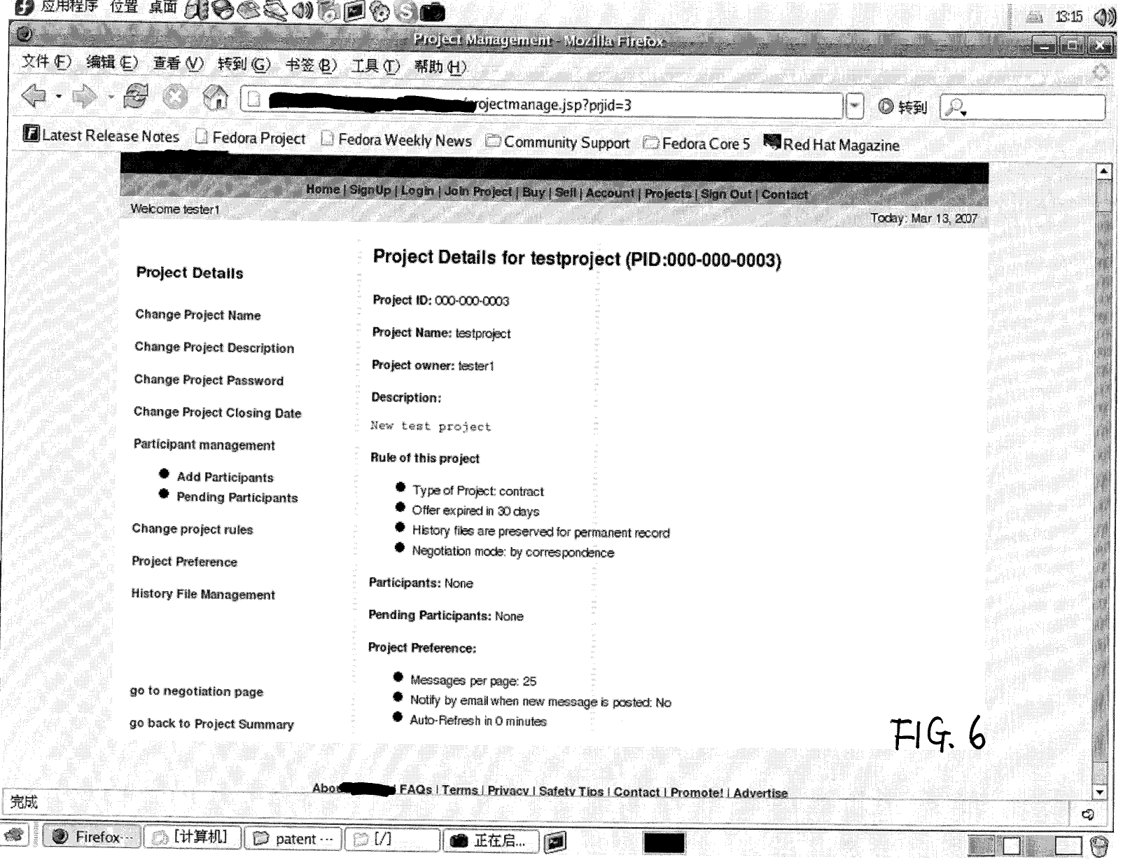

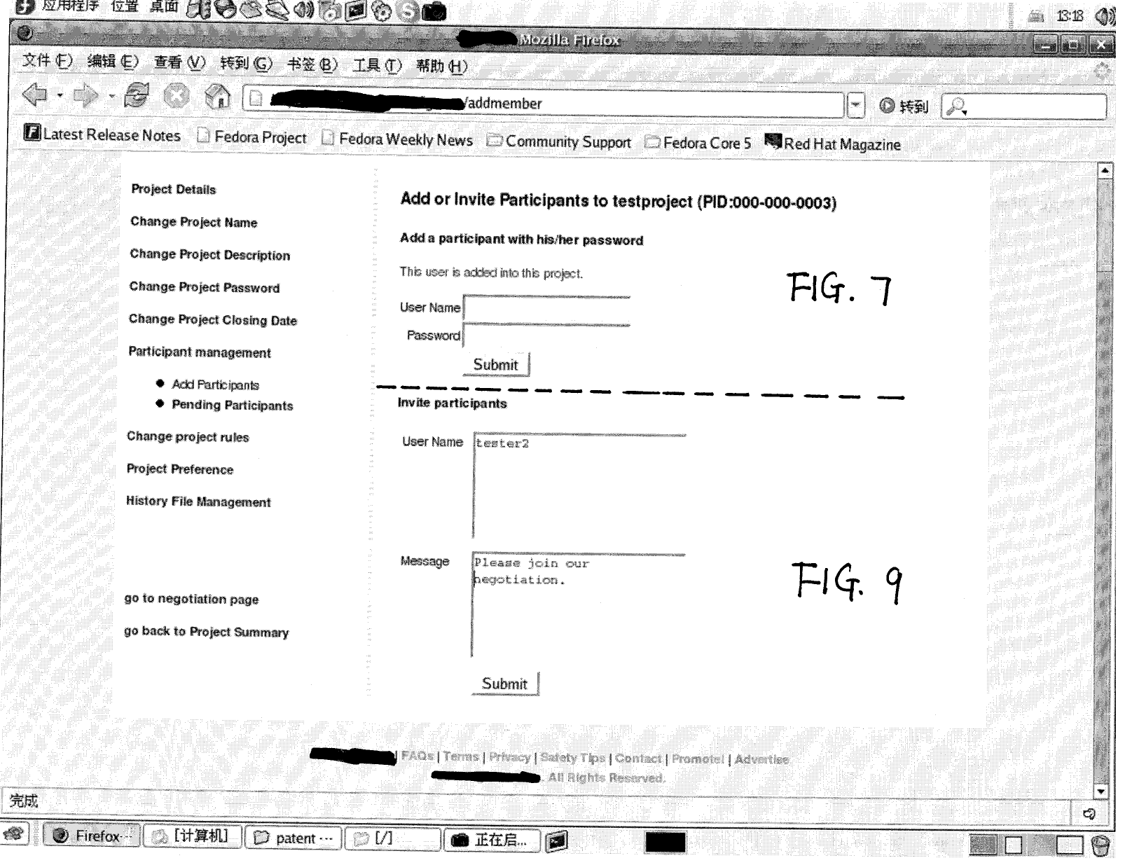

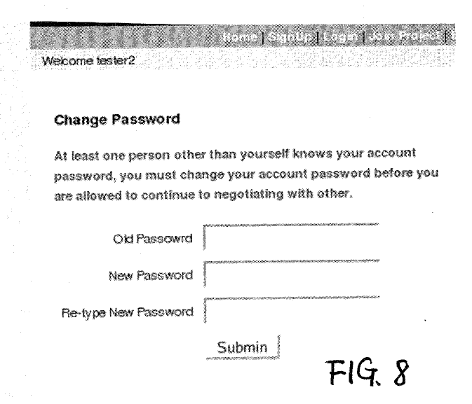

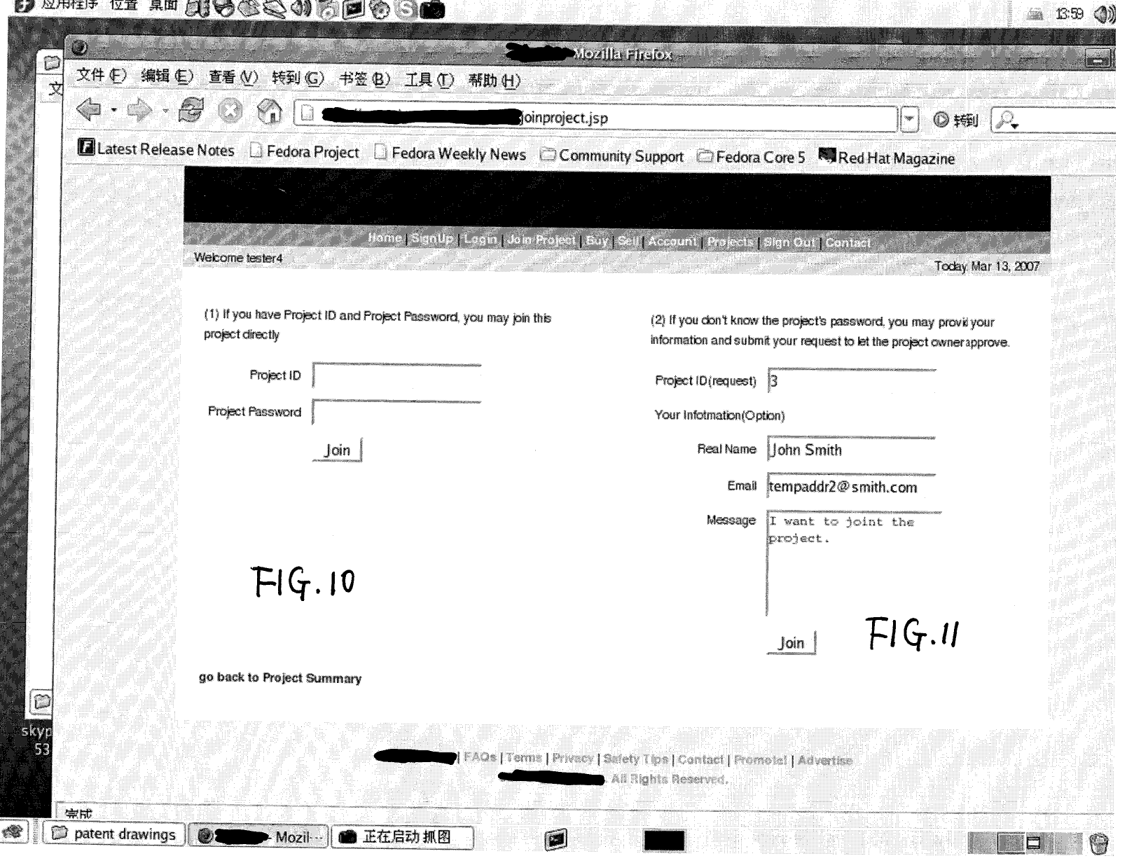

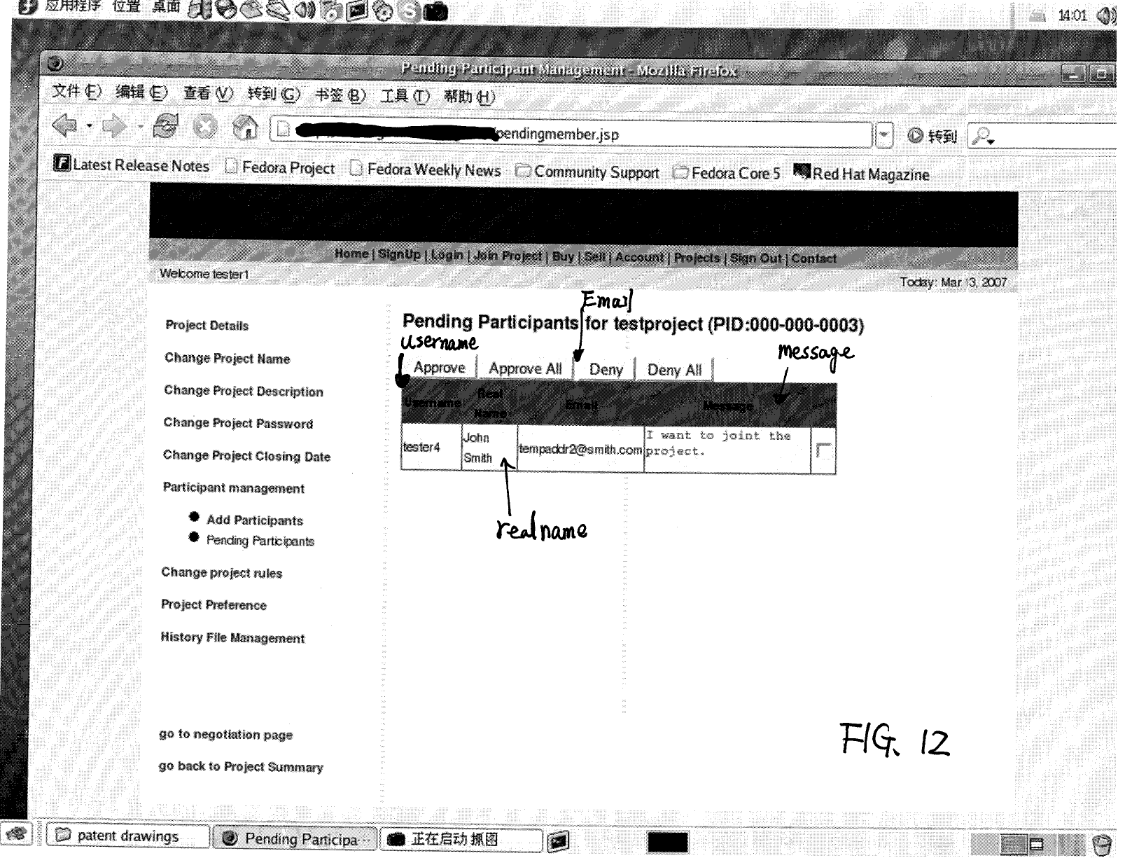

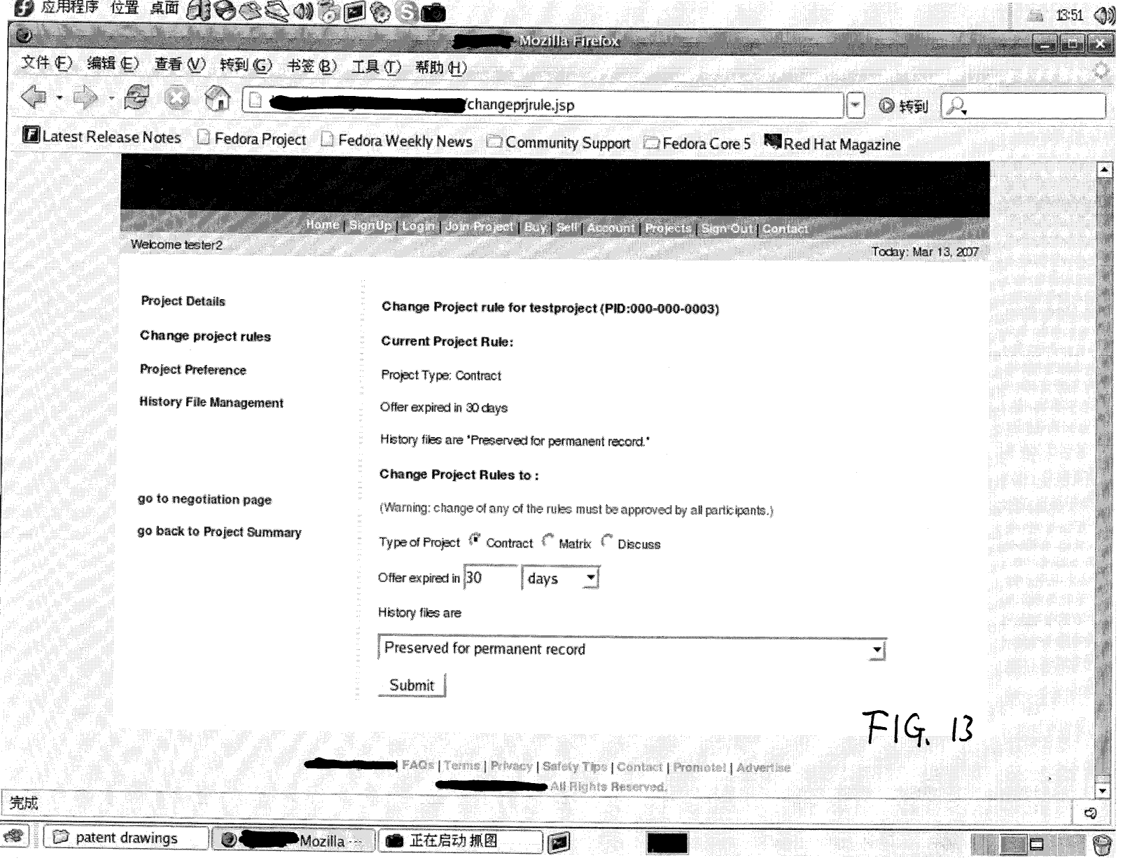

A first party gains access to the negotiation server by opening an account (the account manager on web page is shown in FIG. 3). The first party may click on the project on the account home page to request the server to create a negotiation project (FIG. 4). Then, the party may request the server to grant privilege to other account holders.

In order to invite a party to joint the project, the project owner logs in and opens Project Summary (FIG. 5). On this page, there are four tables showing “owed projects”, “participated projects”, “archived projects”, and “pending invitations” (some are not visible on the FIG. 5). If the owner clicks on “update” at the far right of the test project entry, the server generates a Project Management Page (FIG. 6) showing the project details. By clicking on any of the about 10 menu choices on the left, the owner can change for instance project name, project password, project negotiation rules, and computer preference. If the owner clicks on submit Add Participants, it shows the Add or Invite Participants to testproject on the right pane (FIG. 7). The owner may type in the username tester2 and its password of tester2. The second party tester2 is granted the right to negotiate in the project. When tester2 first logs in, it is prompted to change password (FIG. 8). On the Project Management Page, if the owner does not know the password of tester 2, the owner may just type username, tester2, and a message (FIG. 9). This message may include project ID and password or how tester2 can get the project ID and project password.

When tester2 is logged on, it gets the invitation message. If tester2 wants to join the project, it can open its own account summary page (same as FIG. 5). On its project summary page, tester2 clicks on “join someone's project” on the left menu (FIG. 5) and the server will generate a page (FIG. 10). If tester2 has been give a project code and project password by the inviting message or by other means, it can directly join the project. Otherwise, tester2 can use a second joining method—providing basic information on the right side—and send the information to the project owner tester1 for approval (FIG. 11). Any party, who is aware of the negotiation project, may also voluntarily join the project by using the same method. For example, tester4 may make a request to join the project. When the project owner tester1 logins and opens the project, he is prompted to approve or deny the request of tester4 (FIG. 12).

After all parties have been invited into the project, the first party starts the negotiation by logging in the server and drafts a document, written offer or proposal by using a drafting tool or ordinary word processor. The first party types the file name of the document on the submission panel or gets the full path-filename by browsing directories (the submission panel on FIG. 2). The first party then submits the document for negotiation to the server, and the server then displays the entering of the document on the status board, which will be visible to all parties. The submission party may also enter a comment concerning the document and submits the comment together with the document. The comment will show up on the dialog board (FIG. 2).

It is preferable that an email notification message is sent to the email address of the second party, informing it of the submitted offer by the first party. When the second party logs in, the second party can open the document by clicking on its name/icon and reviews it. If the second party accepts it, it just enters a statement in the submission panel indicating its acceptance and submits it. The negotiation ends. When negotiation ends, the server will announce to all parties and make a copy of the final agreement available to them. Since email notification is an art used pervasively on Internet, it is not necessary to discuss the details here.

If the second party does not agree on the document, it may create its own document, or edit the document of the first party and save it as its own document (e.g., counteroffer). The second party types in or selects correct file path for the document on the submission panel and submits it to the first party. The second party may also type a statement on the message window of the submission panel. After submission, the comment is posted on the dialog board with its date and time of entry. The counteroffer is stored in a folder or database field accessible to all parties, and an entry is posted on the status board with a link so that any of the parties viewing the web page can open the document. Preferably, an email notification is sent to the first party of the submission of the counteroffer. If the first party accepts the counteroffer, an agreement is reached. Otherwise, the process is repeated until an agreement is reached or the negotiation period expires.

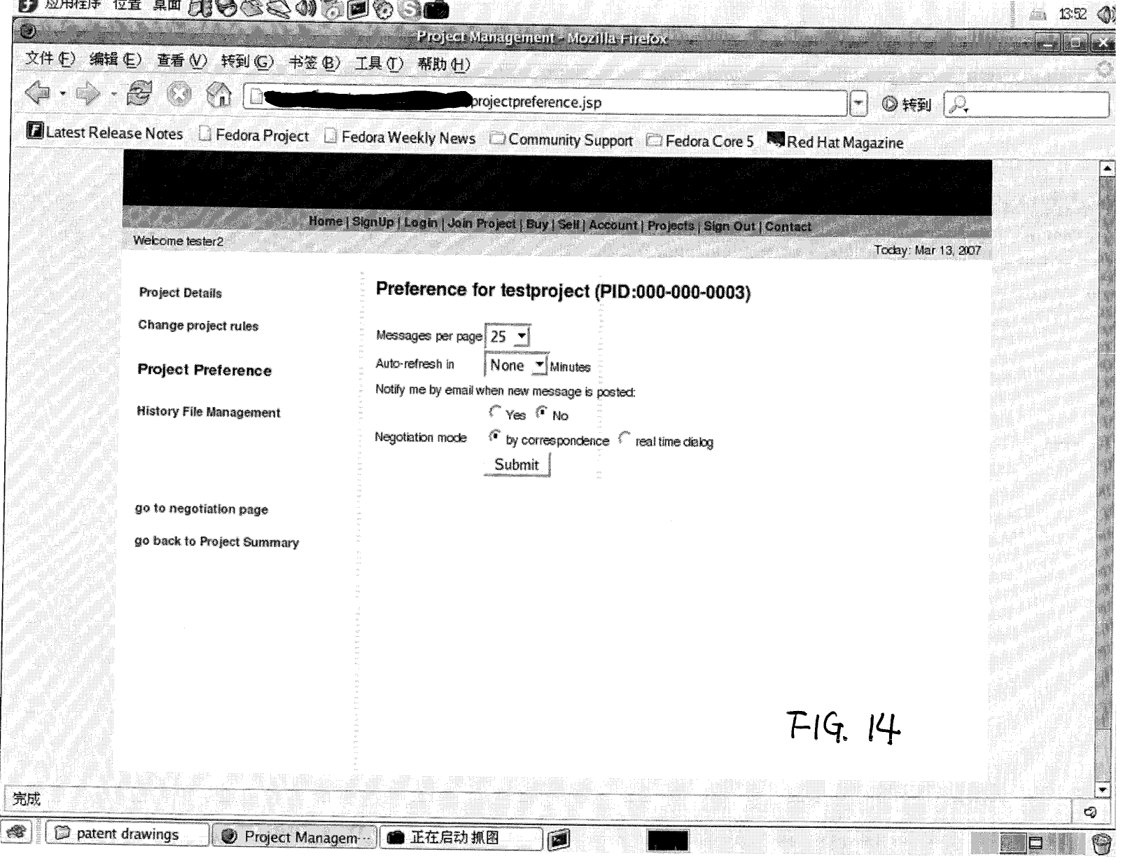

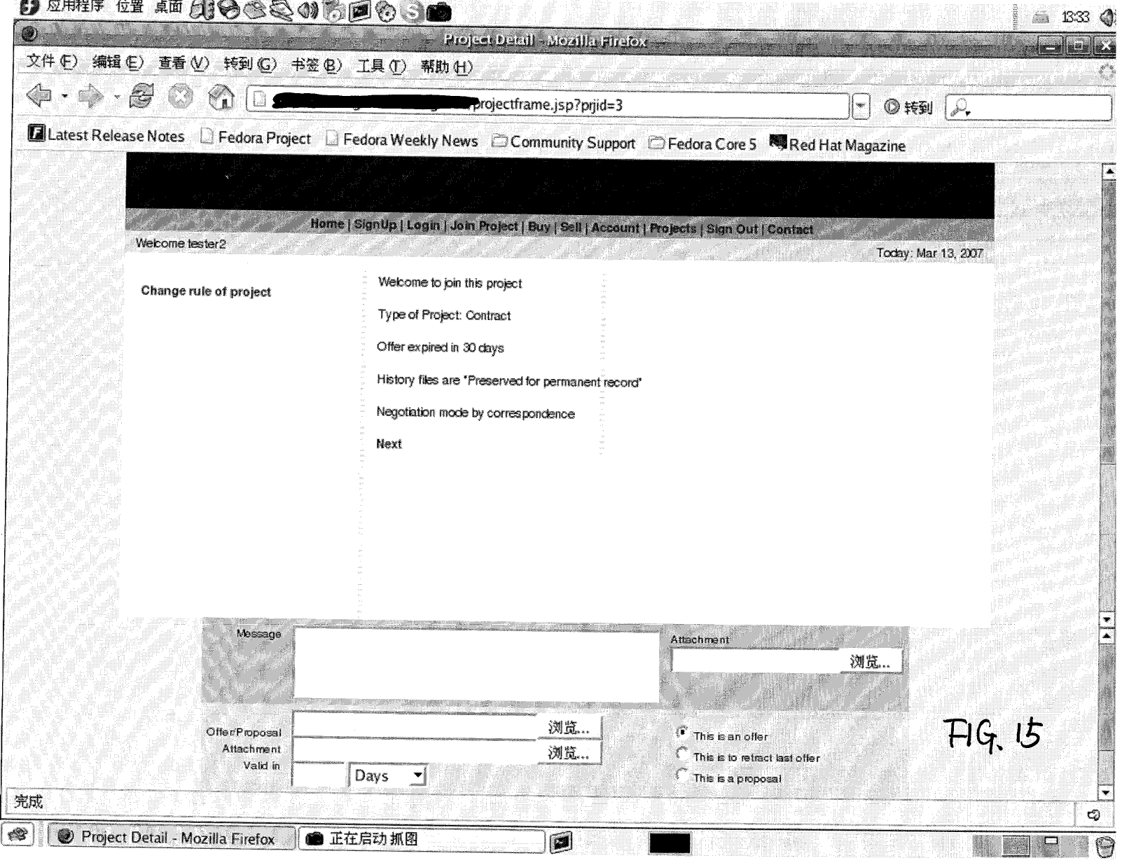

This negotiation system also provides many options. For example, it allows the parties to set negotiation rules (FIG. 13) such as default expiration period, the option to allow a party to explicitly change default expiration rule. The party may also set the rules on how to manage negotiation history files, when to send email notification, and how to change originally set rule in the middle of negotiation. The party also has an option to submit document as offer or proposal when the project is configured for negotiation of contract. The system will mark it accordingly. Finally, the system allows the user to change the message numbers on display, auto-refreshing time, email notification preference, and negotiation mode (FIG. 14). If the refreshing rate is high, the system may be used to conduct real time negotiation.

Secured access is highly desirable but not required. Non-secured assess may be used with or without other digital certificate such as Entrust security (which is used in the website of the United State Patent and Trademark Office's private PAIR).

### C. The Software Components for Negotiation Operations

### 1. Project Manager

The user, who is an account holder, may request the server to create a negotiation project by sending a request to the server. In one of the preferred embodiments, the basic information needed for a project is shown in FIG. 4. The user is prompted to enter a project name, password, and a description of the project, enter a negotiation period and default offer acceptance period (An offer expires after it passes this period), and select a rule on managing history files.

The system provides four modes of negotiation, which are important for the negotiation purpose. If the user selects contract negotiation, the server will enforce many conventional rules governing contract negotiation unless the user specifically changes a rule, and such a change is reasonable in the modern legal environment. The user may select one of four possible negotiation modes. By using matrix negotiation, the project will allow the other parties to negotiate only over a specifically selected terms such as price, delivery term, and warranty period. If the user selects discussion as the mode of negotiation, the system will accept document as proposal (not as a binding offer and counteroffer). This method is especially useful in adopting internal agreement of an organization. It may allow the parties to extend negotiation period so as to explore the best option possible.

The user may also choose the default offer acceptance period of a tendered offer in contract negotiation. If the user chooses discussion as mode of negotiation, then the acceptance period would be the period for accepting a proposal.

The user may also select how to manage negotiation history files. There are three choices available: keeping history files for permanent record, deleting history file at the end of negotiation, and deleting all files at end of a round of negotiation. Some more details are provided as follows:

One of the options is to “preserve negotiation history files for permanent record”. When this choice is used, all documents and statements of the negotiation will be maintained for permanent record. At the end of negotiation, all history files will be archived into a zip file and stored for permanent record. Each of the party may receive this zip file by download or other means. In addition, any of the parties may be able to view those files under the browser just like a project under negotiation.

Another option available is to delete negotiation history files at the end of negotiation. When this option is selected, the server will delete all negotiation files at the end of the negotiation. Negotiation ends when a contract is reached, a proposal is adopted, or when negation is aborted due to expiration of the negotiation period.

Another option is to “delete history files at the end of a round of negotiation”, and this option is useful in the negotiation over the most sensitive subjects such as civil lawsuit, plead bargain, and deals that might be in violation of laws due to unsettled laws. A round of negotiation is considered to be at end when the parties have reached an agreement, the initial offer expires, or all the parties have viewed the pending offer but failed to reach an agreement. Thus, the server will delete all history files (but not the final agreement) when the parties have reached an agreement. If one or more parties have not responded but the offer expired at the end of expiration period of the offer, the server will also delete the history files. If at least one party has rejected the offer, and all parties have accessed the pending offer, the server will delete the history files. By selecting a sub-option which is to be implemented, the party may ask the server to delete history files only after all parties have an opportunity to view a pending offer even though at least one party has rejected the offer. If the negotiation period ends, the server will also delete all history files, regardless of negotiation outcome.

When the history files are preserved for permanent record, the server may use the project password to make a zip file so that only the parties who know this password can open the history file.

After the user sends the project creation form, the server then generates a project ID, which might be a numeric string or an ASCI string. It also creates the following items:
1) At least one public folder for storing project basic information, proposals and offers, dialog file, attachments to the dialog, and schedules (e.g., attachment to an offer and proposal);
2) Log file for storing the dialog of all party on the dialog board,
3) A file for storing information on the status,
4) A file for storing the basic information about the project.
5) Optionally, a file for storing email address list used for sending email notification.

Those files, collectively known as project data files, may be stored in the same folder or in one or more subfolder within different access privileges. Preferably, for the safety and reliability they are placed in a project folder or its subfolders, which can be accessed only by the parties in negotiation. The files may be stored in any folder and their access privilege may be controlled by access permissions. If the negotiation server is operated by a Unix or Linux operating system, the project folder and its subfolder will be readable by all the parties in negotiation (e.g., using a group permission).

The project data may be written into database tables; therefore, project data files also mean the relevant database tables throughout this disclosure when a database is used.

In one of the examples, the steps necessary for creating a project are:
1) A party makes a request for setting up a project;
2) The system generates a project identity which may be a code or a string;
3) Create a folder which may include one or more subfolder for storing copies of all of the proposals and offers;
4) Use the party name as the owner of the project files and folders;
5) All parties of the project are assigned with the group id (may be identified by the project name or code), and grant group access privilege to project's folder and subfolders;
6) Create an empty dialog file, which can be read by all the parties in the group in a way controlled by the dialog manager;
7) Create an empty status file, which can be accessed by all the parties in the group defined by the status manager.

A negotiation system at elementary level may be built to host a limited number of negotiation projects. To show the concept of this invention, there is no need to use database. However, database implementation has two advantages. It can handle a large number of projects and their files efficiently, and it allows users to search their files quickly. To host a large number of user accounts, it is preferable to use a database table. Account management art is used everywhere on Internet. Detailed discussion of database table usage is focused on functions, which are unique.

When the project data is saved in the tables of a database, the tables (Appendix B) holding project data is equivalent to the project folders. Many of the fields are self-explanatory in light of the FIG. 4. “type” holds information about the type of negotiation project, and the “activated” holds the information whether the project is pending or active for negotiation. “Negotiationmode” holds information whether is a real time negotiation (FIG. 14). When the server is called to display a project for a project ID, the project manager uses the information from this table to decide how to show the project on all relevant pages. “Notity” holds a flag indicating whether a notice should be sent to all members of the project when a change in any aspect of the project occurs. “Activated” is used indicate if a project is active for negotiation or pending during the creation period (see project summary page on FIG. 5).

In one of the preferred embodiments, a projectmembers table is used to keep track of the members (Appendix C). This is equivalent to grant those members the right to access all project data. When a member is logged in and authenticated to be a member of a project, the server knows this status by using a session object. Thus, it is unnecessary to authenticate the member on every web page the member visits. All of the member names for each project and some relevant information are stored in this table. The server can identify all members by the project ID or by the membername. Lineperpage is the number of message units to be displayed to the parties on one screen page. In this table, prjid holds project ID. Firstlogin is used to keep track of whether this member logs-in first time, and it may cause the system to display some important message or warning such as asking if the party wants to change the negotiation rules (See FIG. 15). “Notify” is used to signal the system to display a message when the party accesses the project.

In one of the preferred embodiments, the table projectboard (Appendix D) is built to hold dialog statements, offer, the number of attachments to the offer, and the number of attachments to the dialog for each submission. The field “dialog” holds the dialog statement; “id” holds the submission id. Dattachment and oattachment signal if this submission contains an attachment to the offer and an attachment to the dialog statement. Prjid, membername, and id are indexed so that the server can efficiently find any submission by prjid, membername, and submission id. Attachments to the offer and the dialog are not stored other tables.

In one of the preferred embodiments, the table offerpoll (Appendix E) is used to keep track of each of the offers and determine if the offer is still valid. “id” in this table is for the identification of offers. If an offer is rejected by any of the negotiation parties, the offer is marked as invalid, and will be ignored in the subsequent negotiation. Such offer entries may be kept as history files.

In one of the preferred embodiments, a table dialogattachments (Appendix F) is used to hold dialog attachments (see the attachment shown in FIG. 2). The dattachments field in the table projectboard contains the number of attachments. An entry to the table is made only when this number is not zero. In retrieving the project data, the server will search table dialogattachments only when it finds that the value in dattachment is a positive integer. Similarly, table offerattachments (Appendix G) is used to store attachments to an offer. Since some of the offers may be tendered without attachment so this implementation will save disk space.

In one of the preferred embodiments, a table pendingmembers (Appendix H) is used to store information on pending parties. This table keeps a list of pending parties for each of the projects. This table also contains the information about the pending member's email address, real name, and a message for each pending member.

In one of the preferred embodiments, the table pendingprojects (Appendix I) holds information about the owner username and real name, and email address, and message. A project is pending after it is created until it is activated for negotiation.

In one of the preferred embodiments, a table changeprojectrule (Appendix J) is used to keep information on the new rules proposed by a negotiation party. “closeddate” is the date the negotiation period ends. “offerexpiredunit” is the unit for offer acceptance period stored in the field “offerexpired” is day, month or year. Its use is clear when it is viewed in light of FIG. 13.

The table changeprjrulepoll (Appendix K) is used when a party of project wants to change negotiation rules at the middle of negotiation. For a given project, each of the parties will vote if it agrees to the newly proposed rules. If a party rejects the new rules, no further action will take place with respect to the new rules.

The following table archivedprojects (Appendix L) is used to mark the projects that have been archived. Archived projects are shown in FIG. 5 (the whole archived project table is outside the margin). The table on a web page would look like the table for participated projects.

When a database is used to hold offers, attachments to the offers, and attachments to dialog statements, each of the entries is uploaded to a folder for temporary storage, and then written into the right field of a database table. The steps for submitting a text string are described as follows:
1) The party types in a string in the in submission panel;
2) The server gets the value of the string;
3) The server verifies the identity of the person and the project ID.
4) If the system uses common encryption method, server encrypts it.
5) The server writes the string into the corresponding field of the database table projectboard and dialogattachments and offerattachments if attachments are present.

There are two ways to encrypt the files and dialog statements, depending upon what encryption key is used. The server may use a common encryption key for encrypting all of the files. Thus, the server administrator and data warehouse staff will not be able view any of the files. However, it is still possible that some people who know the common key may be able to decrypt the files. For increased security, the server may use a private encryption key, which may be the project password or a specific key known only to the parties in negotiation. This key itself may be encrypted and stored in a key database. Regardless of the difference in key, the general steps for encrypting a file are as follows:
1) If a file is updated by using a file uploading method, the file is first uploaded to a temporary folder and is saved there, the server also saves information on the file type;
2) The server then retrieves an encryption key which may be saved in a key database or any other suitable table in the project database;
3) The sever then encrypts the file using the retrieved key;
4) The sever saves the encrypted file in a project folder or writes the file in a proper field of a database table;
5) The server finally deletes the original file from the temporary folder.

The files saved in the project folder or stored in a project database table are not readable by humans. When a party wants to access a file, the general steps for downloading file are as follows:
1) The server generates a link on a web page for downloading the file, the link contains file type information;
2) A user clicks on the link;
3) The browser makes a request for downloading the file from the server;
4) The server retrieves the file from a folder or retrieve the file from a database field holding the file;
5) The server then retrieves the encryption key;
6) The server decrypts the file on fly using the key;
7) The browser opens the file if the file can be opened by the browser; or prompts the user to save the file on the local computer if the file cannot be opened by the browser;
8) The user then opens the file using a proper application.

Optionally, the system may provide a private storage folder to each party who chooses to use it regardless of whether a database is used. The security of private files is important. For the maximum security, the server may keep all files in an encrypted form. Each of the parties may encrypt files using its own assigned key. Many encryption algorithms are well known. One of them is Blowfish (designed in 1993 by Bruce Schneieris), which takes a variable-length key, from 32 bits to 448 bits.

When encryption is properly used, the parties have sole responsibility to securely keep the key permanently. If the key is lost, the content of private files cannot be recovered. For an important project, such the encryption key should be stored in a third party without disclosing its use and is recoverable in the event of loss. Whenever a party wants to save a file in its private folder, the request contains an encryption flag and a private key. The encryption key itself should be encrypted. Before the file is saved, the file is encrypted and then is written to the disk of the server.

In retrieving the file, the party sends a request together with the file encryption key. After the file is read, the system then decrypts the file before it is sent to the party on a browser. The server will not save the key.

The parties may also have an option to encrypt the group's folder for the negotiation group, preferably, using project password.

### 2. Party Manager

In an implementation without using database, party management is simple: each of the group can access only the project files of the project. Party identity may be managed by shell accounts under Linux operation system.

If this negotiation server is used to host a large number of negotiation projects, database user table (Appendix A) may be used to manage user accounts. This table is like other frequently used user tables except that it has a warning field. This field is used to provide a warning if its password is used by another negotiation party.

Party manager allows any of the parties who are the existing account holders of the negotiation server to grant access privilege to one or more negotiation parties. The two preferred methods are (1) associating an existing account with an existing project and (2) creating a guest account by the existing account holder for another negotiation party.

### (1) Association of an Account with an Existing Project

If a first party makes a request for associating the account of a second party with a created project, the server prompts the party to enter log in information about the second party, the email address of the second party, and the project code. If the first party enters a correct login name, the email address, and project code, the system grants access privilege for the project to the second party. When the second party first accesses the project, it will be required to verify its identity and to send some basic information such as real name and contact address to the first party for verification. If for any reason, the first party finds that the second party is not a right party, the server will revoke the privilege from the second party. Negotiation privilege will be finally granted after the first party successfully confirms the identity of the second party.

In one of the prospective examples, the steps for associating an account with a project are as follows:
1) The first party makes a request for associating an existing account with an owned project;
2) The party manager prompts the first party to enter project identity, login name, email address, and the name of the second party, the information is saved in table pendingmembers, and
3) If all information is verified, the party manager will grant the access privilege to the account to be associated, and grant group access privilege to the second party so that the second party can access all the project files; in one of the preferred embodiments, the membername together with other information is written into the table projectmembers.

If the first party only knows the email address of the second party, the first party may send an invite using the email address and project identity only. The server then searches for the login name associated with the email address. If no such account exists, the server will inform the first party of the non-existence of the account, and ask the first party to assign a guest account to its intended second party. If the email address is valid, the server sends a message to the second party, inviting it to login in. When the second party logs in, it is prompted to express whether it wants to join the negotiation. If it answers affirmatively, the second party is prompted to enter name and contact information and the server sends the information to the first party for verification.

In one of the prospective examples, the steps necessary for associating an account with incomplete identification information are as follows:
1) The first party makes a request for association of an account with an owned project;
2) The party manager prompts the first party to enter project identity, the login name, email address, and the real name of the second party;
3) If the first party enters only email address associated with the account to be associated;
4) The party manager marks the account as unverified account;
5) If the email does not exist, notify the first party that no account exists.
6) If the email address is used by an account holder, the party manager sends email to the second party inviting it to join the negotiation, the notice may be sent by regular email or web email;
7) When the second party logs in, the server prompts the second party to verify its identity, including it own true name and contact information;
8) The sever then sends the identity information to the first party for verification; when the first party is on-line, it sends the identify information to the first party and prompts it to confirm whether the identity of the second party is right; and
9) After the identity being verified, the server grants access privilege for the project to the account of the second party.

If the first party is able to provide login name, associated email address, and name of the owner of the account holder correctly, the server may grant access privilege to the second party without further verification. If the first party knows both the login name and password of a second party, the server will also associate the account with the project directly. In this case, the server will prompt the second party to change password (see FIG. 8) when the second party logs in the next time. When the password of the second party is disclosed to the first party, the server puts a mark on the warning field of the account record of the second party. So, the server displays this message.

Many more subtle variations in authentication are available as long as they will not compromise the security of the project data and will not infringe the privacy and safety of each of the party accounts.

Only the owner of a project has the right to associate an account of a second party with the project, it is equivalent to associating the two accounts through the project. For the convenience, it may be viewed as associating two accounts.

### (2) Assignment of a Guest Account

If a first party wants to negotiate with a second party who is not an existing member of the negotiation server, the first party may assign a guest account for the second party. After the first party chooses this option in a properly displayed menu, the first party is prompted to assign a user name, a temporary password and project id. The system then creates a guest account and associates the guest account with the account of the first party. The guest account is marked as an unidentified account. When the second party logs in the guess account for the first time, the second party is prompted to provide its identity such as name and contact information. Moreover, the second party is prompted to change the password so that the first party cannot access its private folders. After the creation of the guest account, preferably, the system sends an email invitation to the email address of the second party. This message may have a link to the guest account so that the second party can directly log in by clicking at the link. When the second party logs in the first time, the second party is prompted to provide real name and contact information, and the server sends the information to the first party for verification.

If the first party confirms its true identity, the server will make the second party a party of the project group, and grants privilege for access the project.

In one of the prospective examples, the general steps for making a guest account are summarized as follows:
1) The first party makes a request for assigning a guest account;
2) The party manager prompts the first party to enter proposed account login name, a proposed password, together with the project identity and recipient email address, the account information may be generated by server automatically;
3) The sever creates an account by creating a private folder for the second party or an entry in the user table;
4) The server records the password as the provisional password and marks the account as an unverified or unconfirmed account;
5) The server sends an email invitation to the second party;
otherwise, the first party must give an account information to the second party;
6) The second party logs into the new account the first time;
7) The server prompts the second party to provide its true name and contact information, and change the password;
8) The server receives a new password, the real name, and contact information from the second party;
9) Optionally, the server sends the real name and contact information to the first party for further verification;
10) If the first party confirms that the identity of the second party is correct, it will grant the access privilege to the second party. Then, the server marks the guest account of the second party as verified;
11) The server then compares the new password with the old password in file. If there is a substantial difference, the server marks the account as ready. Otherwise, the server will send another email to the second party, prompting it to change its password again; and
12) Upon successful confirmation of the guest account and change of password, the server marks the account as a confirmed account, which is ready for negotiation.

### 3. Negotiation Rules Manager

After a negation group is established, the parties may agree on certain rules governing the negotiation. The negotiation will be governed by what are known as “governing rules”. The system provides a set of rules with default values (FIG. 13) and the parties can change the default values of the rules by agreement.

The Project Management Page (which includes practically all software components) has the option to change many of the rules. Those rules includes the following:
1) The acceptance period within which an offer may be accepted;
2) The right to retract an unaccepted offer before it expires;
3) The deadline to terminate the negotiation;
4) The right to overwrite a governing rule at the time of submission; and

For each of the choices, the system will have a default values (FIG. 13) and the table changeprojectrule (Appendix J). If an offer is tendered by the first party, but not accepted by the second party during the acceptance period, it expires at the end of the period, and cannot be accepted later by any party. The value for acceptance period in this table can be changed. The default rule for retraction (not implemented in the table changeprojectrule) is that a party may retract an offer before it is accepted. The default rule for negotiation deadline is infinite. The parties may set a time period as negotiation deadline. They may also agree whether the default rules can be overwritten by specific instruction of a party at the time of submission. If this is allowed, a party may indicate at the time of submission that the offer will be expired sooner or later than the time period set in the governing rule.

After the project negotiation starts, a party who accesses the project the first time, will be prompted to express whether it wants to change default rules. If the party does not want to change default rules, the party will be allowed to proceed by clicking on Next (FIG. 15). However, the party is reminded that other parties may want to change negotiation rules when they sign in the project the first time.

If the party elects menu to change default rules, it will be prompted with a menu allowing it to change negotiation rules (FIG. 13). After the first party makes the choices, the system then informs the second party if the second party will agree with the selected new rules the very next time the second party logs in. The proposed rules, e.g., the substance of the rules, are stored in the table changeprojectrule (Appendix J) while the voting record is stored on table changeprjrulepool (Appendix K).

If the second party does not agree, the system will inform the first party that the request for changing rules has been rejected and negotiation could continue according to governing rules which is most likely the default rules. The system may allow the first party to revise the rules in one or two more attempts. If no agreement can be reached regarding negotiation rules, the negotiation will proceed according to governing rules of the system. The system will enforce governing rules throughout the negotiation.

If the second party agrees with the changed negotiation rules, the system will accept the rules, and conspicuously displays the modified rules on the negotiation side penal or anywhere they can be viewed by any of the parties in negotiation. The system may also have a menu, which allows the parties to change negotiation rules at any time, effective prospectively. The rules can be changed as long as all parties agree and the system will enforce newly agreed rules prospectively.

In one of the examples, the steps necessary for implementing the steps for changing negotiation rules are:
1) A first party is prompted to change governing rules. Optionally, the prompt contains message that informs all the parties that they have limited rounds of negotiation for changing governing rules. If they fail to reach an agreement on adopting new rules, negotiation will proceed according to the existing governing rules.
2) The first party is prompted to select different values for governing rules.
3) After the first party submits proposed rules and the values are saved on a table like the table changeprojectrule (Appendix J). The system sends a notice to the second party for consent, and the notice will display the proposed governing rules chosen by the first party.
4) If the second party agrees and confirms it, the system uses the proposed rules to overwrite then governing rules in the rule file or the table project to the extent they are applicable; if the parties cannot agree on the proposed rules, the system will prompt the parties to propose new rules starting from the party who rejects the proposed rules or ask the first party to revise its proposed rules, repeating the process from step (3).
5) The system enforces using the rules on the rule file or the table project;
6) The system enforces the governing rules in all future negotiation processes until one party makes a request for changing the governing rules and the remaining parties agree to the change. If the parties are unable to agree to new rules in the allowed attempts, the system will allow the negotiation to proceed according to original governing rules.

If there are more than two parties in negotiation, when a party proposes new rules, it is adopted when all of the parties agree to the proposed rules. However, if at least one party disagrees with the proposed rules, the proposed rules are killed. However, at any point, the parties may again to propose new rules and repeating the process.

### 4. History File Manager

This component of the software allows the parties to set up rules governing maintenance and disposition of negotiation history files. The options on web page are shown on FIG. 13. In the preferred embodiment, a field, historyfiles, is used in the table projects. The system will use this value of this field to enforce the rules throughout the negotiation process. There are several ways of implementing this rule.

First, the project owner who sets up the project has the option to select how to manage history files. Second, after negotiation starts, any of the parties may propose to change the rules governing history files enforceable prospectively to the extent possible.

The system provides means for negotiate over the rule governing the management of history files in the same way as for changing other governing rules. In one embodiment of the present invention, the process for changing the negotiation rules is as follows.

A first party makes a request that the history file be maintained. The request is written in the table changeprojectrule (Appendix J).

Upon the consent by the second party, the system will manage history files according to their agreed new rules. System will save all history files such as dialog log, the status table file, all rejected proposals, rejected and expired offers, and the final agreement and any other files in the project folder. If the parties are unable to reach agreement on new rules governing history files, the system will continue to use the rule that has been selected by the project owner.

In the example of the present invention, the parties may elect to have control over how to manage negotiation history files. In this case, the parties may electively keep negotiation files such as dialog log, rejected proposals, rejected/expired offers, and the final agreement. The parties may delete some of them selectively. What is important is that the rule is placed before the starting of negotiation. The system will not allow the parties to change the rule in the middle of the game as to the earlier history files. Of course, the parties may reach a new agreement as to how to manage history files prospectively. If all parties agree, they can change the system's management of history files prospectively. In a prospective example, the server may generate a page containing a list of the choices as follows:

1. Dialog statements:
a. [ ] deleted at the end of each round of negotiation.
b. [ ] deleted at the end of the negation period.
c. [ ] kept for permanent record.

2. Dialog attachments (not part of offer or proposal):
a. [ ] deleted at the end of each round of negotiation.
b. [ ] deleted the end of the negation period.
c. [ ] kept for permanent record.

3. Draft documents such as offers, counteroffers, or proposes and their attachments:
a. [ ] deleted at the end of each round of negotiation.
b. [ ] deleted the end of the negation period.
c. [ ] kept for permanent record.

4. Last five draft documents such as offers, counteroffers, and proposes:
a. [ ] deleted at the end of each round of negotiation.
b. [ ] deleted the end of the negation period.
c. [ ] kept for permanent record.

If those options are implemented, the historyfiles field in the table projects needs to be replaced by four fields so that different values of each of the fields can represent three or more choices.

The system also allows the parties to set up a rule on managing history file in the event that the negotiation breaks up or deadline is reached without reaching an agreement in a way different from the case when an agreement is reached. In this case, a different value in historyfiles field may be used.

Optionally, at the closing of the negotiation, the history manager generates a statement or summary concerning the negotiation history in plain language. This summary can show a clear picture of the process that the parties submit their offers and proposals before they reached the final agreement.

In the case that the parties elect to delete history files at end of each round of negotiation. The system will delete dialog statements, offers and proposals at the end of each round of negotiation or, in the alternative, immediately after they are rejected. The server keeps and shows only offer or proposal that has not been rejected or the final agreement.

In a prospective embodiment of the present invention, if the project owner and the parties choose to preserve negotiation history files, the steps for maintaining history files are as follows:
1) After the parties agree on the rules on maintaining negotiation history files, the system keeps this rule in a file or in the table projects (Appendix B) and enforces it;
2) If the party selects to keep all history files for permanent record, the server will save all offers or proposals, schedules, and attachments according to the rule;
3) At the end of the negotiation, the history file manager will make a copy of the entire file folder for the project, produce a password-protected zip file, and make it available to each of the parties for downloading; If the project files are maintained in a database, the history file manager will retrieve all of the files with the project ID and save them in a project folder with or without subfolders, and produce a password-protected zip file, and make it available to each of the parties for downloading; and
4) The system may permanently archive a copy of all project files for its own record for a period of time.

If a third-party vendor hosts the negotiation, all negotiation history files and folders are preferably not viewable by the vendor who provides the services. To achieve this end, the negotiation files may be encrypted using a key that is known only by the parties in negotiation as discussed under Project manager.

### 5. Dialog Manager and Dialog Board

The dialog board, viewed on a client computer display, is shown in FIG. 2. The submission panel works together with the dialog board, it is more convenient to describe them together.

Dialog board at the server may be a file for storing the dialog in text. The dialog manager allows a party to write text on the submission panel, to submit it, and cause the server to append it to the file. It has two components: Part of it is in the user interface, which is just relevant HTML or JavaScript code in the submission panel. From web page view, it is a form with some editing functions.

After a party edits a text, the party then clicks on a submission button to submit it.

The functions of the submission panel are (1) indicating submission type such as proposal, offer, acceptance, retraction of an early offer, (2) submitting schedules (e.g., attachments to offers and proposals), (3) submitting attachments for the dialog; and (4) serving as signature of the submission so that the submission has the effect of consent or rejection.

The submission panel may contain options for (1) shortening or extending offer acceptance period, (2) sending an email notification to other parties, (3) uploading signature image, and (4) choose to using additional security features for authenticating the submission.

Some of the functions on the submission panel are shown in the FIG. 2. The party may be prompted to enter its data at prompt if they are not showed on the submission panel. The submission panel may use JavaScript function confirm the submission or conduct formality check.

On the submission panel of the preferred embodiment, a default value 30 (e.g., 30 days is an acceptance period and the 30^{th} is the expiration date), which is consistent with a governing rule, is printed on the text input box. If the party does not enter any specific data to overwrite it, the default 30-day acceptance period will be used by the system. The submitting party may override it and change it. However, the right to override it may be preempted by the governing rule of the project. If the party has disabled this right in the project setup, then those relevant fields are inactive. Additional feature may be added to use private security certificate.

If the submission party chooses to include an attachment to the dialog, the web page component of the dialog manager will prompt the party to find the attachment and includes it on the submission panel using a proper file name and path. If the submission party chooses to include a schedule that is part of an offer or proposal, the party will be prompted to find the schedule and include it on the submission panel. The submission party may include as many schedules and attachments as the party needs unless the server impose limit.

After the submission panel is ready, the party presses the submission key to submit the data. The system optionally prompts the party to confirm that the information is correct. Upon the final confirmation, the dialog manager will send the dialog to the server and appended the dialog text into the dialog file in the project folder or a database field like the dialog field on table projectboard (Appendix D). The client computer also uploads the offer, the attachment to dialog, and the attachment to the offer to the server, which will save them in respective project folders, or in a temporary folder and then write them in proper database fields like the offer field in projectboard (Appendix D), the content fields in table offerattachments (Appendix G) and dialogattachments (Appendix F).

The server through the status manger updates the status board by entering the newly entered offer or proposal together with the schedule to the status table. It then updates the status board for the party who makes the submission. However, the server will not refresh the screen views of other parties who happen to be online. Their screens are refreshed by automatic refreshment of a loaded web page. The timing of automatic refreshment is setup in the preference (FIG. 14).

For an intensive real time negotiation, it may be desirable that dialog file is loaded in a variable in memory (like a session object). This can speed up updating and sending speed. The system may set a time period for keeping the file in memory just like a session object having active life. Because the server might have multiple negotiations, each of the objects should be identified by a unique name such as the project ID. Each of the submissions contains this project ID, its own id, and name of the submission party. If no project ID is used, the sever may find the project ID from the account identity of the submission party if the party attended only one project. When the server receives a new submission, it identifies the submission using the project ID, its own id and the party name, and matches the submission with a variable holding the dialog information and updates the substance in the variable.

### 6. Status Manager and Status Board

The status board, viewed at a client computer, is shown in FIG. 2.

The submission panel works together with the status board so it is convenient to describe them together.

A party, who submits an offer, needs to indicate final consent by typing its e-signature such as /s/ (see the submission panel). Preferably, such a newly submitted offer or proposal should be distinctively marked with a unique icon or color on the status board so that a submitting party can easily see an inadvertent mistake right after submission. It is preferable to provide an opportunity to retract a submission that has been submitted by mistake.

When a party uses this negotiation forum, it drafts an agreement, view the dialog board, or view the negotiation status board. The status board shows following essential components: parties' identities, offer identities, and submission dates. In addition, the party is able to locate and open all submitted documents conveniently.

In one of the preferred embodiments (FIG. 2), the status board may show the parties' identities at the top in parallel. The left column shows the submission date of each offer or proposal. Each of the offers is shown on the table, and each of the submitted schedules is also displayed right next to the offer on the table cell (no schedule was submitted for the test protect). If the party clicks on any of the offers or schedules, the status board will prompt the server to download the file directly for online review. This feature will allow any of the parties to instantly access any of the offers, proposals, and schedules by clicking its name. In the alternative, the status board may be arranged in other suitable format.

Preferably, an icon in unique color may be used to display the link for each of rejected offers and proposals. The system may also use two or more distinctive colors, respectively for rejected offers and proposals. Additional notations and color may be used. Therefore, the status manager needs to determine if an offer or proposal has expired or has been rejected. An offer is rejected if another offer has been tendered or if it was expressly rejected by at least one party.

To avoid the possible confusion when a party submits a dialog without counteroffer, an additional field, “consent”, is added in the table projectboard (Appendix D). When a party submits a statement without counteroffer or submit a proposal without a counteroffer, the server may be unable to understand its decision to the pending offer. Therefore, it is preferable that the party is prompted to check a box if the party accepts or rejects the pending offer. If the party accepts the offer, the party checks on yes. After a submission is made, the server then gets the value for this box and writes it into the “consent” field in a proper format (e.g., N for rejection, I for inaction, and Y for consent).

When a party submits in an offer, the server automatically marks the “consent” field with “N” in the projectboard table. Each time when a party in a negotiation project makes a submission, the status manager also transfer this value to the field “decide” in the table offerpoll with respect to a pending offer. By using the projectboard record, the status manager will determine if a valid contract is formed by looking at the values of in this field for all records associated with the project since the pending offer was posted. If the status manager finds an “N”, it treats that pending offer as rejected. If it finds that all parties in the project have marked “Y” within the expiration period, a contract is declared. If the status manager finds only some members have expressed consent but it has passed the negotiation period, the status manager will also declare the end of the negotiation.

The status manager may also use the table offerpoll to determine if a contract is formed. Each time when a party makes a submission, its decision on consent or rejection is written in the “decide” field (e.g., 0 for inaction, 1 for rejection and 2 for consent). The offer posting date is available in the table projectboard. Optionally, an offer post-date field may be added in the table offerpoll so that the status manger can determine negotiation status without using table projectboard.

On the server side, the negotiation status information may be saved in a formatted file like an Excel table. If there are n parties, there should have n columns. The matrix should be able to hold a sufficient number of entries the parties may enter in the entire negotiation period. There is nothing on the left column. When a party submits an offer or proposal, the system gets the time and date from the server and enters the date and time on the left column right below the party identities or the last submission entry. It prints file's path and name. Before any offer or proposal is entered, the table is empty except that the top row has party identities. To present the data to the party at client computer, the status manage just reads this formatted data, and use the data to build the status board using table format, converting the file paths into links so that the party at the end can download the offer.

In one preferred embodiment of the present invention, the status information is written into the table projects. “offer” is a link, which, upon being clicked, causes the server to find the offer file from the “content” field of the table offerattachments and has it downloaded to the client computer. One sample link is <a href=“downloadoffer?id=2&membername=tester2” target=“-blank”>Offer</a>

Use of different colors and icons on links on a web page is very simple and straight. Since the status manager can determine the status of each of the offers and proposals, it can use different fonts and colors or image icons when it prints links on the status board for the offers and proposals. In addition, in a prospective embodiment, a link may be built between any offer on the status board and the related dialog entry so that when a party clicks on the offer, the color in the relevant message block of the dialog board will change. The party can easily find the related statements for each of the offers.

The status manager enters the filename in the cell crossed by the date/time and the identity of the submission party. While the status manager may use any filename used by the submitting parties, it is preferably to use a systematic name for each of the offers and proposals. The original filename may be replaced by a systematic name before it is saved. The reason is that even though the identity of files in this system can be precisely maintained, but after the negotiation ends, all history files will eventually be transferred to the party. With time passing, there is a substantial chance that the party will lose the information on the dialog files, offers, schedules, and attachments. Due to preexisting errors in naming files, creation dates, and issue dates, the party may again have to decipher the riddle of inconsistency down the road. The naming method will help the parties avoid this kind of problem.

In one prospective embodiment of the present invention, the name comprises first three letters of the party identity together a three-digit number and a type code. “O-ABC-001” means ABC's offer 001 while “P-ABC-002” means ABC's proposal 002.

The naming scheme is flexible. It is intended for easy identification, clear indication of source. Surplus information is necessary in resolving identity issues in the future when the file is found in an isolated folder. The submission date is found in the status board. The number may be a serial number generated for all submitted documents or only for the documents submitted by the party.

To implement the universal serial numbering method, the system needs to keep a record for tracking the number assignment. The record may be a text file or a database field. The record has zero at the beginning. When an offer is submitted, the status manager reads the last serial number string, converts it into an integer, adds it value by one, and converts back to an ASSCI string. It then uses it and saves it again. The ASCI string is used to formulating the name of the file. Next time when another offer is submitted, the status manager will repeat the process. In this way, all files can have a serial number in the name string. If each party uses its own serial number, the system needs to keep track of the serial numbers for all parties by the same method.

The status manager use a database field to keep track of serial number, it needs to convert integer “1” into “001” before it can be appended to the file name.

If a party submits a schedule as part of the offer and proposal, it is also shown on the status table like S-ABC-003-001

In this example, the serial number has two groups of numbers. The first group number is the serial number of the associated offer. The second group of number is a serial number of the schedule. The numbering is flexible. For attachments that are not part of the offer/proposal, they may be coded using the scheme A-XYZ-09/03/2005-001.

This filename means attachment 001 that was submitted by XYZ on Sep. 3, 2005. This file is retrievable by a link on the status board pointing to the attachment. Again any name is permissible but it is preferable to contain sufficient information for identifying the attachment clearly. It is not required to spell out all components in the name string.

When a party submits a proposal or offer, the system will write a new entry, which includes the filename, submission date in the status file. It then causes the system to read the file into memory and determine the rejection-acceptance status for each of offers and proposals. The rule is very simple: only the last un-expired offer is a valid offer. A later proposal cannot operate to reject an earlier offer that has not expired. An agreement is formed only when all parties agree on an offer that has not expired within the negotiation period.

The system then optionally sends out the status information to each of the parties. It may display all rejected and expired offers and proposals with a mark (such as R or E) and/or with distinctive colors.

Since the status board is constructed in runtime using individual data components, it is easy to add a hot link to point to a file having filename O-ABC-001 on the status board. This type of link is used everywhere.

### 7. Email Notification Manager

Optionally, the system contains an email notification manager for sending email upon the happening of an event according to a predetermine scheme. The events triggering the sending of email include:
1) When a party invites another party to change negotiation rules and the rules for managing negotiation history files;
2) When a party sets up a guest account and invites another party to join the negotiation or when the system associates two existing accounts by a project identity;
3) When a party submits a dialog, a proposal or offer;
4) When an offer expires due to lapse of time;
5) When a final agreement is reached;
6) When a party quits the negotiation;
7) When the deadline for the negotiation is reached without an agreement; and
8) When a party's password is given to another party.

When any of such events happens, the email notification manager will send an email message to each of the email addresses according to the predetermined scheme. For different events, the email notification manager may use different email addresses as recipients. It is not necessary to send email to all the parties for each of the events. Email notification may be sent to all parties when a party submits an offer, when an agreement is reached, when a party quits, and when negotiation deadline is reached.

When a party invites a second party to join a negotiation, email is sent only to the second party. If a party has a main email address associated with an account ID, it may also have one or more notification email addresses. The recipients of the notification addresses are informed of the status of negotiation but preferably may not be allowed to submit offers and proposals.

After the project is created, the email notification manager will create plural files for storing email addresses, one address for each of the parties. Optionally, all email address lists may be saved in one single file if different lists are separated by specific event mark such as <dialogsubmission>, <offersubmission> and <negotiationtermination>. The email manager can retrieve the corresponding email address lists for each of events by using those marks. Obviously, the email addresses may be stored on a database table with or without usage-flag.

The email sent to the account's main email address may contain a hot link for accessing the dialog board, the status board and all associated files. The recipient at the account's main email address may be prompted to log in to the account before access is allowed. For the CC or notification addresses, the message may contain the information about the action. Access by multiple persons of a party may be allowed when the party distributes the password and login account ID to other people. The server may impose a limitation on the number of simultaneous accesses.

The implementation of email notification is well known in prior art. For Linux based server, it may use the sendmail program to send email. The message may be prepared and saved in a file or a database field, and the manager reads the file, and sends it using appropriate recipient addresses. The manager may use a series of conditional statements for sending email. Any of the particular events listed above may be associated with a particular email address list and a particular text body. For the example, the email function in a CGI module may be SendNotification (int event, char [ ] textbody, char [MAX][ ] address) { . . . }, where the address contains a list of email addresses, which is read from a file or constructed in runtime. When an event happens, an integer variable is assigned with a value (for example, 1 for invitation, 2 for invitation for change rule, 3 for updating dialog board, 4 updating the status board, and n for termination of negotiation). On the basis on the integer value, the system opens and reads the right text body into the textbody and reads the email addresses from the associated file or relevant section of the file. It then calls the above function and has mail sent. The email text may contain a hot link to the login page.

In one prospective embodiment of the present invention, the general steps for sending email are as follows:
1) Event happens due to user action;
2) Read message from a file consistent with the event;
3) Retrieve correspondent email addresses from a file or database field for the event;
4) Process the message body and, if necessary, add a link; and
5) Send the email message to the recipients in the list.

Sometimes, email is not sent until a certain action takes place without human action. For example, when all parties are inactive in an entire negotiation period, and negotiation ends as a result of expiration of time, the server needs to check whether negotiations are terminated for lapse of time. The action of searching expired negotiation projects should be scheduled to take place around midnight each day, and the message manager should finish sending out such messages before the start of next work day. Such scheduled email may be sent in a Linux machine by using cron software component.

### III. The Use of the Negotiation System

### A. Formal Negotiation

This negotiation method is intended for formal negotiation. By using this method, a party can tender only offer and counteroffer. There is no room for submitting a proposal for discussion.

After a project is created, the first party may request the system to associate its account with one or more negotiation parties under the project identity. In the alternative, the first party may create a guest account for each of the negotiation parties. After the access privilege is granted to all negotiation parties and account security is in proper order, the parties are ready to negotiate.

A first party starts drafting an agreement and, upon finishing it, submits it to the status board for the second party to consent. The system then displays the offer, preferably by using a systematic name, on the status board. The file is saved in the project folder or database tables. If the second party logs in and expresses its consent by submitting an e-signature, an agreement is reached. A valid agreement is formed only when all the parties express affirmative consent to an offer that has not been rejected, nor expired.

If the second party does not want to act, it may log out the server without killing the pending offer of the first party. If the second party writes an entry in the dialog board without submitting an offer, system will prompt the second party to indicate if it rejects the offer on the status board (not shown in FIGS). In other words, the second party has an option to reject or not reject the offer when it only sends message to the dialog board when it does not submit its own offer or counteroffer. This allows the parties to keep pending offer for further consideration. After the second party takes its action, the first party will see the action of the second party and takes its action again.

Before the offer is accepted and rejected, the system marks it as active and valid using a distinctive color and notation on the status board. If the second party rejects the offer, the second party has on option to create its own counteroffer using the drafting resource or ordinary word processor and submits it, preferably, with an e-signature. If the first party agrees on the counteroffer, an agreement is reached. If the first party rejects the counteroffer of the second arty by tendering its own counteroffer, no agreement has formed. The parties may repeat the process until both parties arrive at an agreement or the time period for negotiation expires. When an agreement is formed, the system will make a copy of the final agreement for permanent record.

Only the last offer that has not been rejected and has not expired is marked as an active/valid offer. All unaccepted offers other than the latest offer are marked as rejected offers. Expired offers are marked as expired offers. If the status board has only expired offers, the system will not allow a party to accept an expired offer to form an agreement. A party may reactivate a rejected offer by resubmitting it for acceptance by the other party. The submitting party can do so by opening the rejected or expired offer, moving it to the entry space for the current day under in its own column. The renewed offer gets a new systematic name. The status board may be designed to allow a party to move any of the rejected and expired offers to the current day only for itself. In the alternative, the party may open any of the rejected and expired offers, edit it and save it on the client machine, and resubmit it to the status board.

During the negotiation process, any of the parties may enter a message in the negotiation dialog board to discuss any issues. If the parties set the negotiation rule that allows party to overwrite governing rules at the time of submission, the party may enlarge or shorten the time period for acceptance. The system keeps track of the expiration day for such special offers.

If the parties have chosen to maintain negotiation history files, the system will copy and save a copy of negotiation history files permanently for a period of time after the negotiation ends. The history files include all rejected offers, all expired offers, the dialog log, and the file containing status information. The system may pack all files in one folder, zip it, make it available for download, or deliver it by email to each of the parties at the end of the negotiation. The parties may be permitted to download history files within a period of time.

If the parties have chosen not to keep history files, the system deletes history files according to the preference the parties have chosen at the end of each round of talk or the negotiating period. If the parties have made a special rule on managing history files in the event that the negotiation breaks up, it will enforce the rule accordingly.

While the discussion is for two parties, the method is equally applicable in negotiation by multiple parties. To change the negotiation rules, all party have to agree to the proposed rules. An offer may be rejected by any of the party who tenders a counteroffer, and an agreement is formed only when all parties agree to an offer that has not expired within the negotiation period.

### B. Informal Negotiation

This method is similar to a discussion forum and is useful in informal negotiation. According to this method, a party may tender oth offer and proposal. If a party submits a proposal, other parties cannot accept it to form a binding agreement. By using this negotiation forum, the cost of negotiation will be so low that resenting proposals for consideration is justified. The parties are informed by the system that a proposal is only used as a bridge for meeting of mind. Proposals may be used to narrow the distance between parties in reaching an agreement. Preferably, the system displays proposal and offer on the status board in conspicuously different icons and colors.

If a proposal is posted on the status board, the other party is expected to provide feedback, edit it and submit it, or create its own proposal. The second party may submit a proposal for consideration or tender an offer for acceptance. When a party makes a submission, it indicates in the submission panel whether it is an offer or proposal.

The system will display the status on the status board accordingly. If an offer in status board is rejected, the system marks it as rejected offer by using a distinctive color. If a proposal is overwritten by a counter proposal, the system marks it as rejected proposal. Rejection of a proposal will discourage parties from further considering the proposal.

The negotiation may proceed as follows. After the first party submits a proposal or offer, it then sends a notice to the second party by phone or an email notice. The second party logs in the server to check for offer and proposal.

If the submission of the first party is a proposal, the second party may avoid taking any action, enter a comment in the dialog board, tender its own counter proposal for simultaneous discussion, or tender its own binding offer. If the second party does not want to act, it just logs out the server without killing the active proposal of the first party. The second party may open the proposal, read it and submit a feedback to the dialog board by using the submission panel. The second party may also edit the proposal and submits it as its own counter-proposal. This may be possibly viewed as rejection of the pending proposal of the first party. The second party may also submit an offer to the status board, and thus by implication reject the first parties' proposal. The party may set up their own rule allowing the proposal to be further considered.

If the original submission of the first party is an offer, the second party may log out without taking any action, submit a comment to the dialog board without killing the pending offer, submit a comment with an express intent to reject the pending offer, submit a new proposal for consideration without killing the pending offer, or submits a counteroffer to reject the pending offer of the first party.

When the second party makes a submission to the dialog board, system prompts the second party if it rejects the proposal or the offer on the status board. The second party has an option to reject or not reject pending proposal or offer when the second party merely enters a dialog statement without submitting offer or proposal. This allows the parties an option to keep any offer or proposal for further consideration.

After the second party takes its action, the first party again takes its action. They repeat the process until an agreement is reached. If the second party has provided a counteroffer, the first party may revive its own proposal for further consideration without killing the counteroffer of the second party. After the second party has offered a counteroffer, the first party's proposal will be marked as rejected proposal (however, different effect may be given by using a different rule). A valid offer on the status board cannot be rejected by a subsequent proposal unless the party expresses its intention at the time of submission. This precedence rule is useful because considering party of an offer can keep the offer alive and has a chance to test if the tendering party will be willing to entertain a different deal (In essential, it would be a counteroffer). It is perfectly acceptable that a party might want to keep an offer alive but yet wants to explore the room for negotiation.

The parties will repeat the process until an agreement is formed or negotiation ends. All unaccepted offers are marked as rejected offers and all rejected proposals are marked as rejected proposals. When an agreement is formed or negotiation ends, the system will take care of history files according to governing rule as in the formal negotiation case.

The negotiation forum may be used as real time negotiation. A plan for real time negotiation may be facilitated by scheduled arrangement, telephone notification, and email notification. Each of the parties may be informed of the date and time for the negotiation. Each of the parties is requested to prepare its own documents for the review by other parties. During the negotiation, all parties can review the documents of other parties, and express its position to accept or reject proposals and offers of other parties.

The system will enforce history files according to its own rule. The history files include all rejected/expired offers, all rejected proposals, the dialog log file, email address lists, and the files containing the status information. If the project files are stored in database, the server eventually needs to retrieve them and save them in files in a folder. They may be archived as one zip file.

While the above examples are provided for two parties, it is obvious that the method is useful in negotiation by multiple parties. To change the negotiation rules, all party have to agree on the change.

An offer may be rejected by any of the party's counteroffer and any party's express intention of rejection. Proposal itself will not serve to reject pending offer unless an intention is expressed at the time of submission. An agreement is formed only all parties agree on a valid offer that has not expired within the negotiation period.

It should be pointed out the rules are tentative. For informal negotiation, there are no formal rules. The governing rules are whatever the parties agree.

### C. Formal and Informal (Dual-Mode) Negotiation

The negotiation forum is particularly useful in dual-purpose negotiation: internal negotiation and external negotiation. If a party in litigation wants to tender an offer of settlement, its attorney and all decision-makers of the first party need to draft an offer that is acceptable and approved by the decision-makers. In the first phase, the attorney of the first party drafts a proposal for discussion and posts it in the status board. Negotiation will proceed until the decision-makers reach an agreement on the terms of the offer. The attorney then logs into a different account, which has a negotiation project with the second party, which is an adversarial party. The negotiation proceeds as a formal negotiation. If the offer is accepted, the negotiation ends.

If the second party rejects the offer and tenders a counteroffer, the attorney of the first party presents the counteroffer to the decision-makers of the first party in informal negotiation. If the counteroffer is acceptable to all the decision-makers, the attorney logs in the external account again and expresses the consent of the first party to the counteroffer. The negotiation ends.

If the decision-makers do not agree on the counteroffer, the further negotiation among the decision-makers may reach a new counteroffer for the second party. This process of reviewing counteroffers by the decision-makers, drafting a new counteroffer by the decision-makers, tendering the counteroffer to the second party, rejecting the counteroffer by the second party, and receiving an newer counteroffer from the second party may be repeated again and again until the negotiation ends or an agreement is finally reached.

Such a negotiation forum can reduce negotiation costs and shorten negotiation cycles. For the safety of parties' information, the two servers may be hosted in two different machines at two different locations: the machine hosting the internal negotiation may be completely controlled by the party or a credible commercial vendor. It is desirable that an independent party should administrate the server that hosts the negotiation between two adversarial parties.

### Appendix A

create table users(
id int insigned auto_increment primary key,
username varchar(20) not null unique,
password varchar(20) not null,
email varchar(50) not null unique,
firstname varchar(20),
lastname varchar(20),
title varchar(4),
address varchar(50),
city varchar(20),
state varchar(2),
zip varchar(5),
country varchar(20) default ‘USA’,
phone varchar(12),
rank tinyint insigned default 0,
refer tinyint unsigned default 0,
created_date datetime,
logintime datetime,
warning tinyimt insigned default 0,
activated char(1) default ‘Y’);

### Appendix B

create table projects(
id bigint unsigned auto_increment primary key,
name varchar(50),
owner varchar(20),
description text,
created_date datetime,
expired_date datetime,
password varchar(20),
lineperpage tinyint unsigned default 25,
refresh tinyint unsigned default 0,
notify char(1) default ‘N’,
type tinyint unsigned default 0.
offerexpired tinyint unsigned default 0,
offerexpiredunit tinyint unsigned default 0,
historyfiles char(1) default ‘O’,
negotiationmode char(1) default ‘S’,
activated char(1) default ‘Y’);

### Appendix C

create table projectmembers(
prjid bigint unsigned,
membername varchar(20),
lineperpage tinyint unsigned default 25,
refresh tinyint unsigned default 0,
notify char(1) default ‘N’,
rank int default 0,
firstlogin tinyint unsigned default 0,
PRIMARY KEY(prjid,membername));

### Appendix D

create table projectboard(
prjid bigint unsigned,
membername varchar(20),
id int unsigned not null,
dialog text,
dattachment tinyint insigned default 0,
filename varchar(255),
filetype varchar(50),
type char(1) default ‘O’,
oattachment tinyint unsigned default 0,
post_date datetime,
expired_date datetime,
offer MEDIUMBLOB,
PRIMARY KEY(prjid,membername,id));

### Appendix E

create table offerpoll(
prjid bigint unsigned,
offerprovider varchar(20),
id int unsugned not null,
member name varchar(20),
decide tinyint unsigned default 0,
PRIMARY KEY(prjid,offerprovider,id,membername));

### Appendix F

create table dialogattachments(
prjid bigint unsigned,
member name varchar(20) not null,
filename varchar(255),
type varchar(50).
content MEDIUMBLOB,
primary key(prjid,membername,id) );

### Appendix G

create table offerattachments(
prjid bigint unsigned,
membername varchar(20) not null,
id int unsigned not null,
filename varchar(255),
type varchar(50),
content MEDIUMBLOB,
primary key(prjid,membername,id)
);

### Appendix H

create table pendingmemebrs(
prjid bigint unsigned,
membername varchar(20) not null,
realname varchar(50),
email varchar(50),
message text,
primary key(prjid,membername) );

### Appendix I

create table pendingprojects(
username varchar(20),
projid bigint unsigned,
realname varchar(50),
email varchar(50),
message text,
primary key(username,projid) );

### Appendix J

create table changeprojectrule(
prjid bigint unsigned primary key,
membername varchar(20) not null,
requestdate datetime,
closedate date,
type tinyint unsigned default 0,
offerexpired tinyint unsigned default 0,
offerexpiredunit tinyint unsigned default 0,
historyfiles char(1) default ‘O’ );

### Appendix K

create table changeprjrulepoll(
prjid bigint unsigned,
membername varchar(20) not null,
agree char(1) default ‘Y’,
primary key(prjid,membername)
);

### Appendix L

create table archivedprojects(
prjid bigint unsigned,
archiveddate datetime
);

What is claimed is:

1. A negotiation system for at least two parties to negotiate over a document or a transaction, the system comprising:
A negotiation server having a network interface and being connected to Internet;
At least two client computers, each of the client computers connected to the Internet, being used by one of the at least two parties in negotiation;
Meaning for creating a project by using browser at one of the client computers, assigning project code, and providing storage for keeping project basic information, offers, proposals, attachments, dialog files, and a status files;
Means for associating an account with the project or by assigning a guest account;
Means for submitting dialog statement and attachment to the dialog board where the dialog is displayed;
Means for submitting documents, offers, proposal, attachments to the status board for display, wherein the offers and attachments are available for downloading or viewing;
Means for the party to indicate whether it accepts or reject a pending document, offer, or proposal;
Mean for determining whether an offer has expired, the negotiation ends, and an agreement is reached;
Means for changing governing rules on offer expiration date, the right to override a governing rule, and right to retract a document, offer, or proposal under negotiation;
Means for sending email notification to at least one parties upon user action or an natural event; and
Means for changing the rules governing negotiation history files and enforcing the rule in one of the three ways: deleting history files at each round of negotiation, deleting history files at end of the negotiation, and keeping history files for permanent record.

2. A computer program product for use in a system, the computer program product comprising a computer usable medium having computer readable code embodied on the medium, the computer program code further comprising:
code residing in the server for generating web page containing a dialog board, a submission panel and a status board, to be rendered on the client computer;
code for creating project ID, project basic information, project data files, and grating access privilege;
code for associating an account with a project or assigning an account for use with a project by setting permission or create a project member table;
code on the submission panel for accepting text statement and accepting files, submitting statements, attachments, and offers and schedules to the server for processing and storage;
code on the dialog board for showing party identity, statements, attachments, and submission dates, and for updating, displaying and downloading dialog statements and attachments;
code for determining if an offer has expired, rejected, if an agreement has been formed and if the project has expired;
code on the status board for showing party names, submitted papers, and submission dates, and for downloading and displaying documents, offers, and attachments;
code for allowing a party to propose new rules at start of negotiation or in the middle of negotiation, allowing all parties to vote on proposed rules, if they parties adopt new rules, writing the newly rules into files or database, and enforcing new rules;
code for allowing parties to select governing rule on managing history files, and processing history files in one of the ways: deleting history files at each round of negotiation, deleting history files at end of the negotiation, or keeping history files for permanent record.
code for sending email invitation to prospective parties for joining negotiation, sending notice upon user action, or automatically sending notice to the parties concerning activities in project.
